(19) United States
(12) Patent Application Publication
(10) Pub. No.: US 2017/0061152 A1
(43) Pub. Date: Mar. 2, 2017

(54) SYSTEM AND METHOD FOR MULTI-TENANT HEALTHCARE RELATIONSHIP MANAGEMENT

(71) Applicant: hc1.com, Inc., Indianapolis, IN (US)

(72) Inventors: Brad BOSTIC, Indianapolis, IN (US); Jason WOLFGANG, Indianapolis, IN (US); Mark PRESTON, Indianapolis, IN (US); David SUTTON, Indianapolis, IN (US); Tom COOPER, Indianapolis, IN (US); Seth ELY, Indianapolis, IN (US)

(73) Assignee: HC1.COM, INC., Indianapolis, IN (US)

(21) Appl. No.: 15/120,208

(22) PCT Filed: Mar. 25, 2015
(86) PCT No.: PCT/US2015/022408

§ 371 Date: Aug. 19, 2016

Related U.S. Application Data
(60) Provisional application No. 62/106,833, filed on Jan. 23, 2015.
(60) Provisional application No. 61/972,049, filed on Mar. 28, 2014.

(51) Int. Cl. G06F 21/62; G06F 19/00

(52) U.S. Cl. CPC G06F 21/6245; G06F 19/3418; G06F 19/322

(57) ABSTRACT

A computerized method and system for healthcare relationship management is disclosed. The method includes receiving a health information from a healthcare communication source at a healthcare relationship system, categorizing the health information into at least one security category based on one or more privacy rules, receiving a request from a user for the health information at a healthcare relationship management system, the user being associated with at least one security role, and granting or denying access to the health information for the user at the healthcare relationship management system based on an evaluation of the at least one category against the at least one security role.

### CROSS REFERENCE TO RELATED APPLICATIONS

The present application claims the benefit of commonly owned U.S. Provisional Patent Application Ser. No. 61/972,040 filed on Mar. 28, 2014 and U.S. Provisional Patent Application Ser. No. 62/106,833 filed on Jan. 23, 2015, both of which are hereby incorporated by reference in their entirety.

### BACKGROUND

All healthcare organizations acquire and maintain a significant amount of data. Most are able to organize the data into information that identifies service-level deficiencies, failures to properly exploit opportunities, or other business gaps. Some organizations are able to use this vast amount of data to generate contextual intelligence that may assist in identifying these problem areas. However, today, no healthcare organization is able to efficiently identify these deficiencies, isolate their root causes and use this analysis to create actionable, targeted, and tracked tasks for individuals while maintaining the security, privacy, integrity, and availability of critical healthcare data.

Some healthcare organizations attempt to identify problem areas by deploying internal healthcare insight around a localized data warehouse. These solutions are problematic in that business analysts must pour over data to find and prove high-level problems for management review. Once the problems are identified, the business analysts must again pour over the same data to generate individualized reports that might turn these problems into actions. However, these processes are disparate and rely on warehoused (stale) data; these processes do not allow for any intelligent action and corresponding response to be taken, whether it be automated or manual. In the time it takes healthcare organizations to identify problems and corresponding solutions, new problems may be realized and/or solutions to old problems may no longer be relevant.

Finding an efficient way to identify problem areas within a healthcare organization with correlations between warehoused data and real-time or near real-time data would dramatically improve the intelligence and capability of these healthcare organizations to react to these problems. Creating actionable items directly from these identified problems will ensure that problems are not just identified, but there is continuous improvement in those key areas—this cycle of problem identification driving decisive action creates closed-loop accountability. In addition, automatically associating incoming communications with individuals would improve efficiency in problem resolution. Accordingly, there exists a need for a method and system for healthcare relationship management.

### BRIEF DESCRIPTION OF THE DRAWINGS

FIG. 1 illustrates a flowchart of a method for healthcare relationship management.

FIG. 2A illustrates a flowchart of a method for healthcare relationship management according to at least one embodiment of the present disclosure.

FIG. 2B illustrates a flowchart of a method for healthcare relationship management according to at least one embodiment of the present disclosure.

FIG. 2C illustrates a flowchart of a method for healthcare relationship management according to at least one embodiment of the present disclosure.

FIG. 2D illustrates a flowchart of a method for healthcare relationship management according to at least one embodiment of the present disclosure.

FIG. 2E illustrates a flowchart of a method for healthcare relationship management according to at least one embodiment of the present disclosure.

FIG. 2F illustrates a flowchart of a method for healthcare relationship management according to at least one embodiment of the present disclosure.

FIG. 3A displays the architecture of a system for healthcare relationship management according to at least one embodiment of the present disclosure.

FIG. 3B displays the architecture of a system for healthcare relationship management according to at least one embodiment of the present disclosure.

FIG. 3C displays the architecture of a system for healthcare relationship management according to at least one embodiment of the present disclosure.

FIG. 3D displays the architecture of a system for healthcare relationship management according to at least one embodiment of the present disclosure.

FIG. 3E displays the architecture of a system for healthcare relationship management according to at least one embodiment of the present disclosure.

FIG. 4 displays the architecture of a system for healthcare relationship management according to at least one embodiment of the present disclosure.

FIG. 5 displays a screenshot of a user interface presented in association with a system and/or method for healthcare relationship management according to at least one embodiment of the present disclosure.

FIG. 6 displays a screenshot of a user interface presented in association with a system and/or method for healthcare relationship management according to at least one embodiment of the present disclosure.

FIG. 7 displays a screenshot of a user interface presented in association with a system and/or method for healthcare relationship management according to at least one embodiment of the present disclosure.

FIG. 8 displays a screenshot of a user interface presented in association with a system and/or method for healthcare relationship management according to at least one embodiment of the present disclosure.

FIG. 9 displays a screenshot of a user interface presented in association with a system and/or method for healthcare relationship management according to at least one embodiment of the present disclosure.

FIG. 10 displays a screenshot of a user interface presented in association with a system and/or method for healthcare relationship management according to at least one embodiment of the present disclosure.

FIG. 11 displays a screenshot of a user interface presented in association with a system and/or method for healthcare relationship management according to at least one embodiment of the present disclosure.

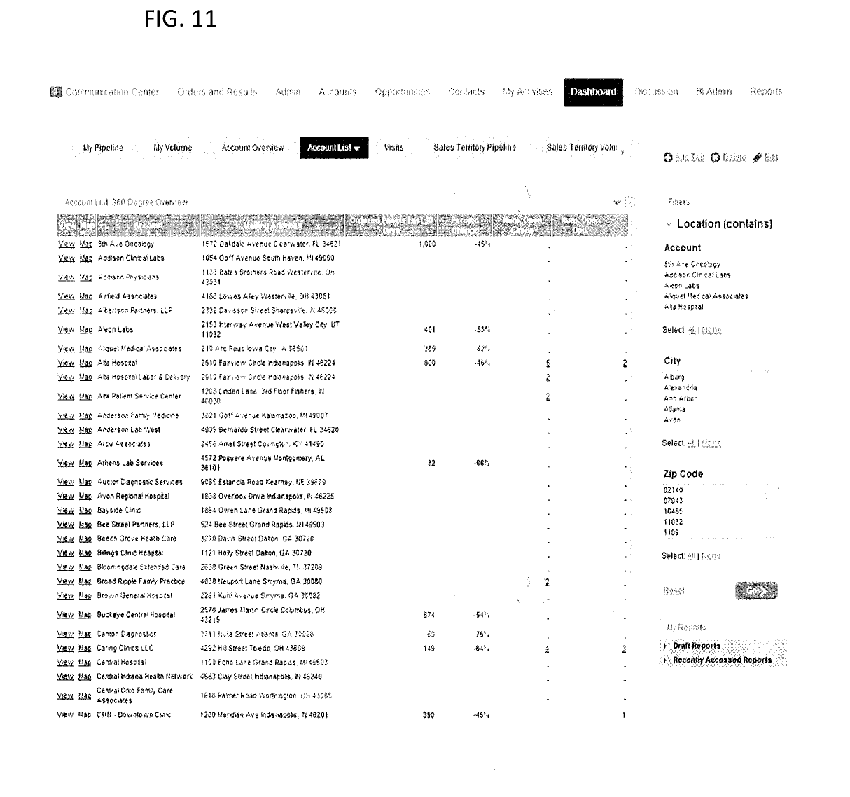

FIG. 12 displays a screenshot of a user interface presented in association with a system and/or method for healthcare relationship management according to at least one embodiment of the present disclosure.

FIG. 13 displays a screenshot of a user interface presented in association with a system and/or method for healthcare relationship management according to at least one embodiment of the present disclosure.

FIG. 14 displays a screenshot of a user interface presented in association with a system and/or method for healthcare relationship management according to at least one embodiment of the present disclosure.

FIG. 15 displays a screenshot of a user interface presented in association with a system and/or method for healthcare relationship management according to at least one embodiment of the present disclosure.

FIG. 16 displays a screenshot of a user interface presented in association with a system and/or method for healthcare relationship management according to at least one embodiment of the present disclosure.

FIG. 17 displays a screenshot of a user interface presented in association with a system and/or method for healthcare relationship management according to at least one embodiment of the present disclosure.

FIG. 18 displays a screenshot of a user interface presented in association with a system and/or method for healthcare relationship management according to at least one embodiment of the present disclosure.

FIG. 19 displays a screenshot of a user interface presented in association with a system and/or method for healthcare relationship management according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language-interpreted, compiled, or otherwise. These languages may include, but are not limited to, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Nodej s, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services and/or service-oriented architecture through one or more application programming interfaces or otherwise.

As used in the present disclosure, a healthcare organization may include, but is not limited to, a doctor's office, a hospital, a pharmacy, a laboratory, a healthcare information system, a radiology group, a healthcare service provider, an integrated delivery network, an accountable care organization, a healthcare insurance company, a wellness organization, or other organization within the healthcare industry.

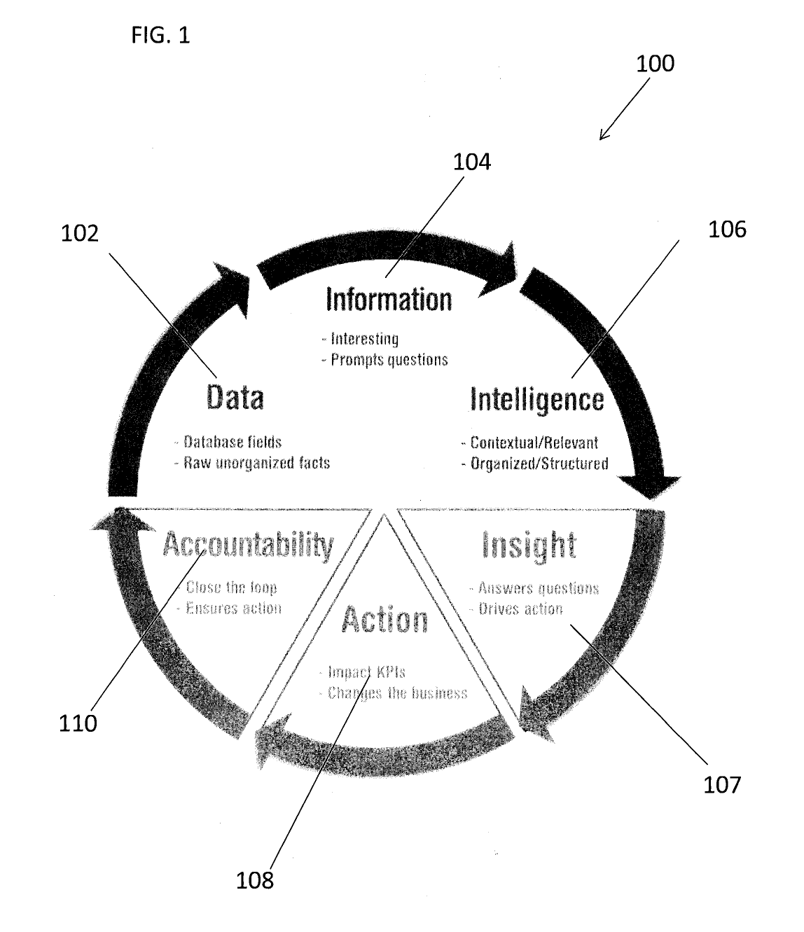

Referring now to FIG. 1, it is shown a flowchart of a method 100 for healthcare relationship management according to at least one embodiment of the present disclosure. As shown in FIG. 1, the method 100 includes receiving raw healthcare data in step 102, organizing and structuring data to find problem areas in step 104, organizing and structuring data to find contextual and relevant relationships in step 106, identifying solutions to problem areas from the data in step 107, calling the solutions to action in step 108, and ensuring accountability to the actions in step 110.

In at least one embodiment of the present disclosure, the method 100 includes receiving raw healthcare data in step 102. In such an embodiment, a healthcare organization may receive and/or obtain raw healthcare data from a variety of resources. Such resources may include, but are not limited to, a lab information system, radiology information system, hospital information system, electronic medical record, data warehouse, revenue cycle management system, general ledger, accounts payable provider, a billing provider, a customer relationship management solution, and others. A healthcare organization receiving and/or obtaining such data may store the data in one or more locations, such as, for example, a database or data warehouse. Information retrieved or obtained during step 102 may include, but is not limited to, lab test orders, lab test results, radiology orders, interpretive radiology results, physician information, patient information, prescription information, patient encounters, scheduling, insurance information, patient payment information, turnaround time, ordering location information or other information from one or more of the information resources.

For example, a laboratory that processes diagnostic lab tests (i.e. CBC, RBC, WBC, blood lead testing, and the like) may store information concerning such tests and associated results in a laboratory information system and/or laboratory management system (“LIS”). In this example, in step 102, information from the LIS may be received through an application programming interface, web services infrastructure, or other data creation methods. Data may also be created from a LIS through simple exports of data in comma separated value, raw text, sockets, or otherwise and then uploaded to the healthcare relationship management system. In addition, data may be retrieved from an electronic health information repository through HL7 TCP/IP and/or an HL7 real-time feed.

In at least one embodiment of the present disclosure, the method 100 includes organizing and structuring data to find problem areas in step 104. In such an embodiment, raw data obtained from various sources in step 102 is categorized and organized within a system in step 104. After organizing the data into a reviewable structure, opportunities for improvement may be identified through analysis of the data. For example, an organization ingesting a totality of metrics surrounding lab tests conducted may find that lab tests, on average, take longer to turn around than the organization's goal. In another example, an organization ingesting prescription data for patients may find that a certain type of medication, on average, is being prescribed to more patients than expected. In another example, a hospital may uncover, by ingesting prior patient prescription information, that an individual patient has experienced multiple negative results from prescribed medications during a single hospital stay identifying that a certain prescription should not be used. In a final example, a testing instrument may indicate a result reading that is either inconsistent or inaccurate; based off of this result, an indication can be surfaced that result remediation may be required.

In at least one embodiment of the present disclosure, a healthcare relationship management system enables an organization to identify contextual and relevant information within the organized and structured data related to the problem areas in step 106. In such an embodiment, the problems identified in step 104 are analyzed to identify relevant and contextual data surrounding such problems. For example, if an identified problem includes a certain medication being prescribed at an above-average rate, then the contextual and relevant data related to this problem may be a listing of individual doctors and data surrounding medication prescription rates. In another example, if a problem is identified related to the average time that it takes a lab test to close, contextual and relevant data surrounding this problem may be individual worker time-to-close rates for a lab over a period of time.

In at least one embodiment of the present disclosure, a healthcare relationship management system enables an organization to look deeper into the aggregate data to find solutions to the problem areas in step 107. In such an embodiment, problem areas identified from organized data on the average, over a window of time, or with a certain business group may be analyzed further to determine root cause. For example, if laboratory tests are taking, on average, longer than expected, an organization may drill into the raw data to find specifically why these lab tests are taking longer. In one instance, the data may be skewed due to an individual employee taking much longer than all other employees. In another example, a collection of testing instruments can be inspected to verify quality, consistency, and average output. In another instance, the data may show that a customer is generally slow in getting all of the information needed to perform a lab test to the organization. In another example, an organization may drill down into a finding that a certain medication is being prescribed over the expected rate to see that an individual doctor is prescribing this medication to a very high percentage of patients.

From these root causes, an organization may create actionable tasks in step 108. In step 108, the organization may take the data associated with the root cause and assign a solution to address the root cause to an individual employee or team within the healthcare relationship management system. The employee or team with the assigned task will then be required to remediate the root cause by implementing the solution. In step 110, by assigning the task to an individual employee or group, the healthcare relationship management system can ensure the action is completed by the assignee. Then, the method 100 may repeat its steps as new data is obtained, new problem areas are discovered, new solutions are identified, etc.

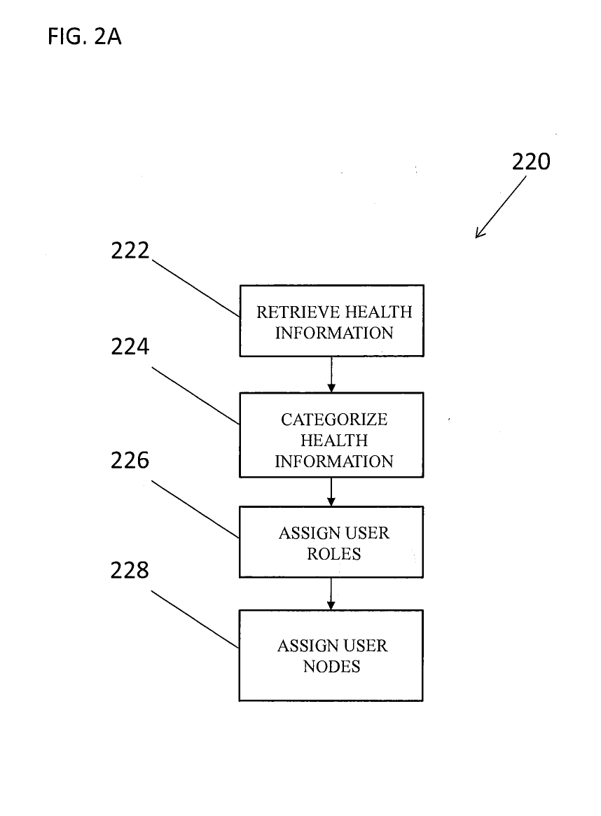

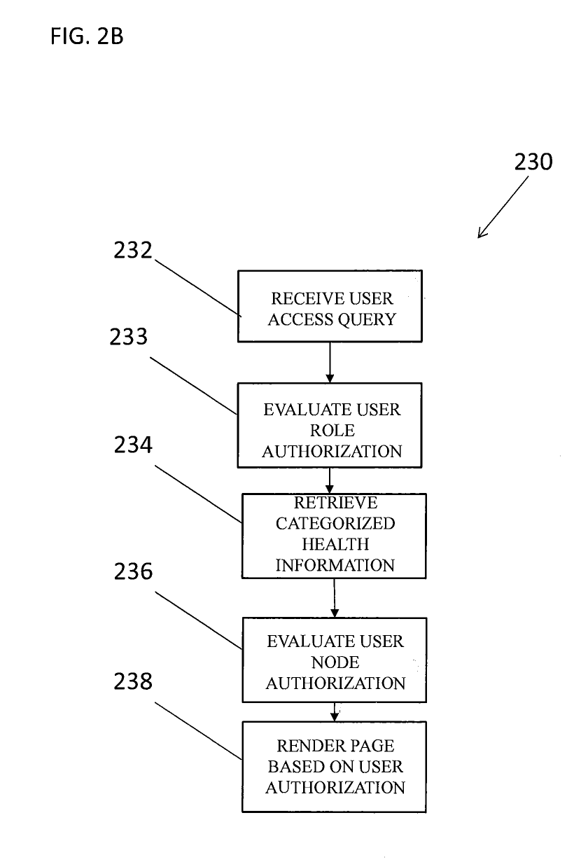

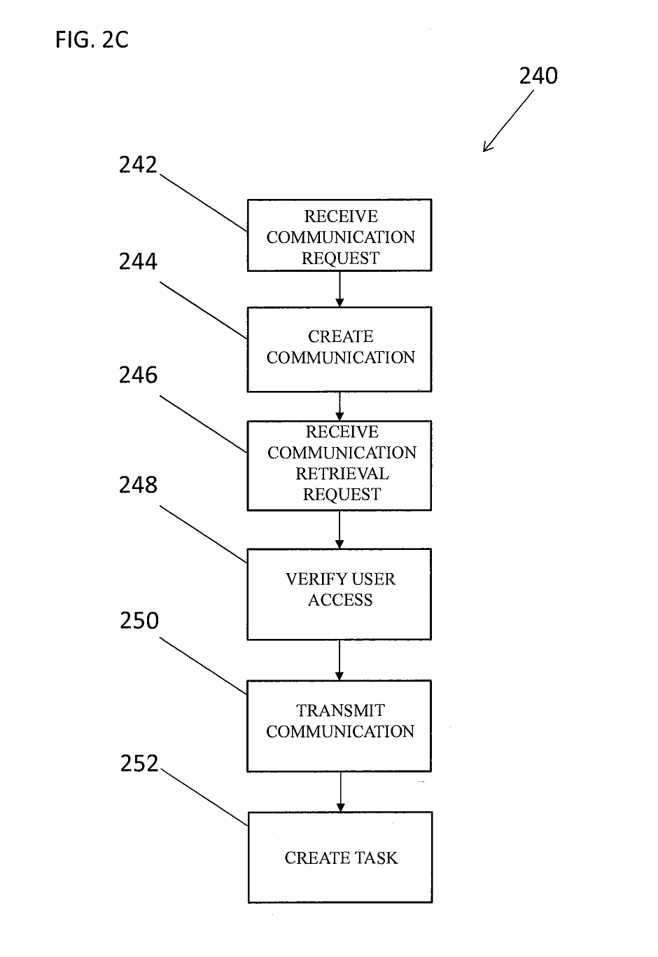

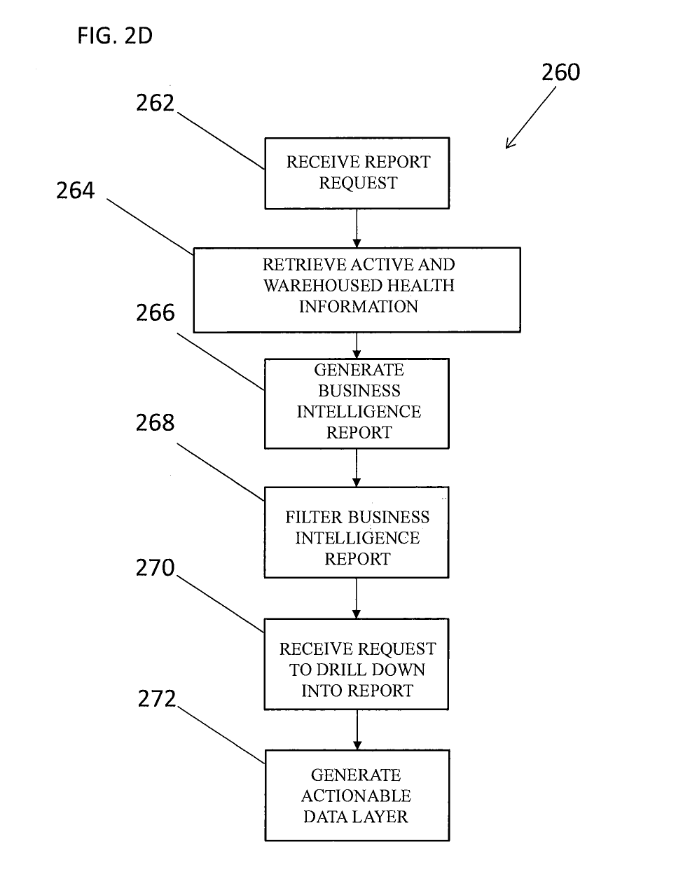

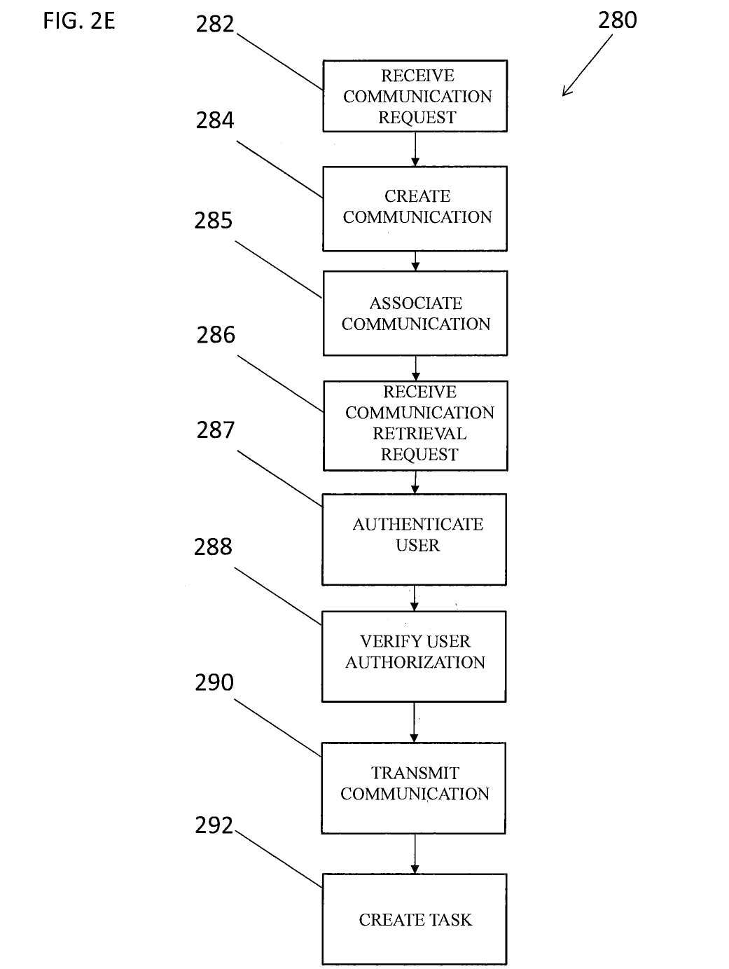

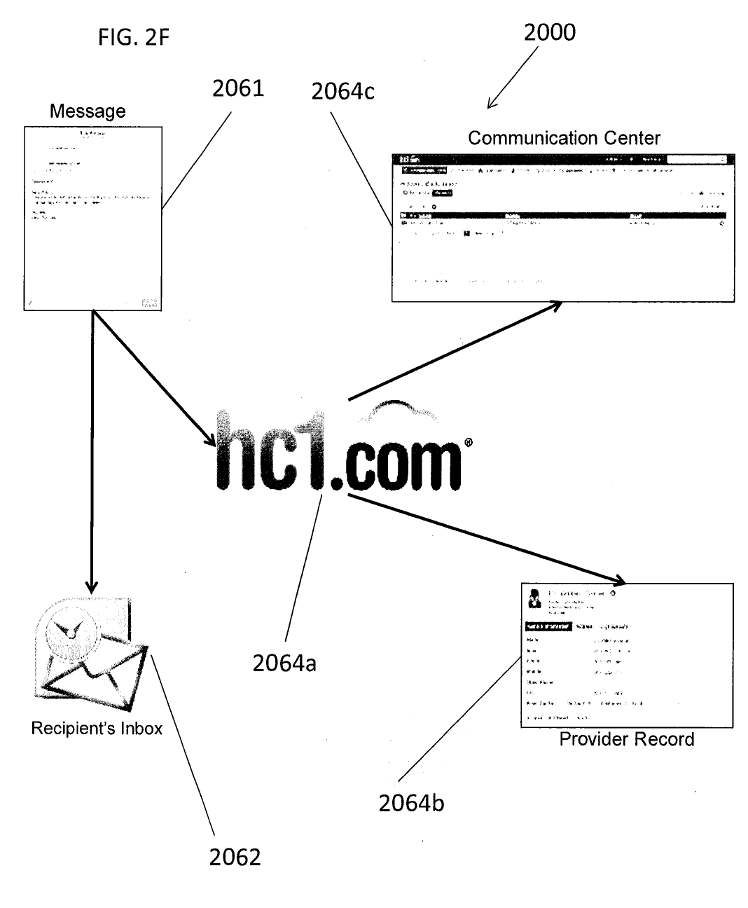

Referring now to FIG. 2A, it is shown a method 220 for healthcare relationship management. As shown in FIG. 2A, the method 220 includes retrieving health information in step 222, categorizing health information 224, assigning user roles 226, and assigning user nodes in step 228.

In at least one embodiment of the present disclosure, the method 220 includes retrieving health information in step 222. In such an embodiment, a system may retrieve or receive health information from one or more resources, such as, for example, as discussed in step 102 of the method 100. In at least one embodiment of the present disclosure, the health information is categorized in step 224. In such an embodiment, portions of the health information may be categorized to identify whether information is protected health information (“PHI”) under one or more regulations, laws, privacy commitments, or otherwise and, therefore, should be protected in accordance with additional care than other information. In such an embodiment, portions of the health information may be categorized as confidential and, accordingly, should be treated with additional care than other information. In addition, portions of the health information may be categorized under need-to-know classifications for various roles within an organization. Such classifications may be stored in a database, data management utility, or third party resource.

For example, an enterprise performing various types of lab tests for laboratories or hospitals may categorize some information received from a LIS as PHI according to the Health Insurance Portability and Accountability Act and its supporting regulations (collectively, “HIPAA”). In this example, the categorization indicates that this information is only to be viewed by individuals with a need to know and protected in accordance with HIPAA. In this example, the categorization may be stored within a column of a database corresponding to the categorized information. In another example, the categorization may be stored in a separate database with a reference to the categorized information. It should be appreciated, of course, that the categorization may be stored in any variety of ways provided that the healthcare relationship management system can retrieve the categorization and the information categorized.

In at least one embodiment of the present disclosure, the method 220 includes assigning user roles in step 226. In such an embodiment, the healthcare relationship management system may include one or more defined users. In a preferred embodiment, for each user in the system, in step 226, the users are assigned roles according to each user's job description. For example, a user in the sales department may be assigned a sales role. Similarly, a user in the operations department may be assigned an operations role.

In at least one embodiment of the present disclosure, the method 220 includes assigning user nodes in step 228. In such an embodiment, each user in the healthcare relationship management system may be assigned a node corresponding to a hierarchical view of the healthcare organization for the user. The hierarchical view for the healthcare organization may take the form of a tree with stems that segment the organization into one or more business areas, regions, or other delineation. For example, a hierarchical view of an organization may be created related to each State in the United States where the organization is located. A user that provides operations support in Atlanta, Ga. may be associated with the Georgia leaf in the hierarchy. A user that provides managerial support over a sales team in Chicago, Ill. may be associated with the Illinois node. In another example, a healthcare organization may create a hierarchical view of the organization based on a simple structure of the entity into disparate business units. In this example, a large hospital may create separate nodes for different practice types, like dermatology, oncology, general practitioners, and the like. It should be appreciated, of course, that the hierarchical view of the organization may take on any structure to create a set of nodes and the examples discussed herein are merely examples.

It should be appreciated that each user may be assigned to more than one node. For example, in a hierarchical view of an organization with separate leaves based on States, a user providing sales to the Midwest region may be associated with the nodes for Illinois, Iowa, Missouri, and other Midwest States. In another example, a manager overseeing IT support personnel working in the dermatology and oncology departments may be associated with both the dermatology and oncology nodes, provided, of course, that the healthcare organization has created a hierarchical view of the organization based on practice type.

It should further be appreciated that a healthcare organization may create multiple hierarchical views. As discussed above, for example, the hierarchical view based on State of practice may be used in connection with the hierarchical view based on practice type. In this example, a manager of dermatology and oncology sales with personnel in Missouri and Illinois may be associated with the dermatology and oncology nodes in the hierarchical view based on practice type and the nodes for Missouri and Illinois in the hierarchical view based on States of the United States.

In at least one embodiment of the present disclosure, the combination of assigning user roles in step 226 and assigning user nodes in step 228 may enable a healthcare organization to provide role-based and node-based access control to information. In such an embodiment, a user's role may authorize his or her access to certain types of information and the user's node membership may authorize his or her access to individual records.

For example, a care coordinator for a large hospital based in multiple geographic regions is given the task of calling recently discharged patients and attempting to get these patients to schedule checkups with their assigned general practitioner in the hospital. In this example, the hospital itself is based in Florida and Georgia, but the care coordinator only practices in Florida. Accordingly, the care coordinator is assigned the role of care coordination in step 226 and the node of Florida in step 228. The care coordinator is not assigned to the node for Georgia.

In this example, the care coordinator's assigned role gives him or her access to personal information of patients stored within the healthcare relationship management system so that the care coordinator may make calls to patients. The role, therefore, authorizes the care coordinator to access a patient's name, phone number, email address, medical condition, recent procedure performed in the hospital, and last date of visit to his or her general practitioner. In this example, the care coordinator's role does not grant him or her access to additional information about patients stored in the system, like each patient's blood type, because this information is not necessary for the care coordinator to perform his or her job of attempting to schedule a checkup appointment for the patient with his or her general practitioner.

In this example, the care coordinator's node provides an additional layer of protection. If the care coordinator attempts to view patient records in Florida, the care coordinator's membership to the Florida node authorizes this access. However, if the care coordinator attempts to access a record for a patient in Georgia, the care coordinator is denied access because the care coordinator is not a member of the Georgia node.

The above description describing an improved level of security is exemplified in execution of the method 230 of FIG. 2B. As shown in FIG. 2B, the method 230 includes receiving a user access query in step 232, evaluating user role authorization in step 233, retrieving categorized health information in step 234, evaluating user authorization in step 236, and rendering a page based on user authorization in step 238.

In at least one embodiment of the present disclosure, the method 230 includes receiving a user access query in step 232. In such an embodiment, a user through a user device may attempt to access a page for rendering as transmitted by the healthcare relationship management system over a computer network, such as, for example, the Internet. As used in the present disclosure, a user device may include, but is not limited to, a laptop, desktop, personal computer, smartphone, tablet, wearable technology, smart television, or other network-capable electronic device. In step 232, the healthcare relationship management system receives a transmittal request from a user device at a front-end web-server infrastructure.

In some embodiments, the transmittal request may prompt the healthcare relationship management system to request that the user provide access credential and/or otherwise authenticate to his or her identity to the healthcare relationship management system prior to performing any other steps in the method 230. In such an embodiment, the user device may authenticate to the healthcare relationship management system by providing a username and password, referencing a previously generated session (i.e. through a cookie), through a third-party authentication provider (i.e. OAuth, openid, or others), providing a trusted certificate, token or other one-time pad resource in addition to PIN, or other authentication mechanism.

In at least one embodiment of the present disclosure, the method 230 includes evaluating the user role authorization in step 233. In such an embodiment, the healthcare relationship management system may determine whether the user transmitting the access query for a page has authorization, by role, to view the page and/or information requested. For example, if the user is requesting a page that contains patient credit card payment information and the user is assigned to an intern role which does not have access to any patient credit card payment information, then the healthcare relationship management system may deny the user access query and not retrieve any requested information.

It should be appreciated that the role-based authorization may be performed in a variety of ways. In some embodiments, the application layer of the healthcare relationship management system may query a database for the user role and compare the retrieved role to each information requested in the user access query to determine whether the user is authorized, by role, to retrieve the requested data. In other embodiments, the database, data structure, or data repository where the data is stored may have an inherent authorization model.

In at least one embodiment of the present disclosure, the healthcare relationship management system retrieves categorized health information (i.e. from step 234 of the method 220) based on the user access query in step 233. In such an embodiment, the application layer of a healthcare relationship management system may retrieve any data requested by the user which the user is authorized to view based on role. In such an embodiment, the healthcare relationship management system may present the data to the user device through a web services infrastructure, web server layer, or other presentation layer over a computer network, such as the Internet. In some embodiments, the healthcare relationship management system may pull the authorized data at an application layer from a database and present the authorized data through a web server or other presentation layer.

In some embodiments, the method 230 includes evaluating user node authorization in step 236. In such embodiment, each record of information requested by the user (i.e. row of data, a patient, etc.) is evaluated against the user's assigned nodes (i.e. through the step 228 of the method 220) to determine whether the user is authorized to view each requested record. For example, a user who manages the northeast region of a hospital's support team may have assigned nodes for Maine and New York. In this example, the healthcare relationship management system may evaluate each retrieved record from step 234 to determine whether the node assignment of the user in Maine and New York is authorized to view such records. In the event that the user is not authorized to view any records, the healthcare relationship management system may elect to not present such data to the user when transmitting a page for rendering the data request in step 238.

It should be appreciated that it may be desirous to enable a user to view a page even if the user's node assignment does not authorize the user to view all of the records requested to be rendered in a page, provided the user's role grants the user access to the functionality provided in the page. It should be appreciated, then, that it is possible a user may request a page with data included where the user is authorized to view some records on the page but not all records. For example, a user viewing a report listing all sales transactions entered within the last month may only have access to the records associated with a subset of the month's entered sales records based on node assignment.

In at least one embodiment of the present disclosure, a healthcare relationship management system may be configured to render a page that masks records that the user is not authorized to view based on node assignment. In such embodiments, the page for rendering on the user device may include malformed data, masked data, or otherwise unreadable data where the unauthorized data would usually be presented. In such an embodiment, the page with the malformed or unreadable data enables the unauthorized employee to perform his or her job function for the data that the employee is authorized to view.

Referring now to FIG. 2C, it is shown a method 240 for healthcare relationship management. As shown in FIG. 2C, the method 240 includes receiving a communication request in step 242, transmitting the communication in step 244, receiving a communication retrieval request in step 246, verifying user access in step 248, creating a communication in step 250, and creating an actionable task in step 252.

In at least one embodiment of the present disclosure, the method 240 includes receiving a communication request in step 242. In such an embodiment, a healthcare relationship management system is configured to present a user with a portal for secure and data-rich communication within the system. The communication portal enables users of the healthcare relationship management system to send communications to other users or themselves with references to information stored within the system. When rendering the communication for the recipient, the healthcare relationship management system verifies whether the recipient is authorized to view data referenced in the communication and may apply masking techniques or otherwise not present the data to an unauthorized user.

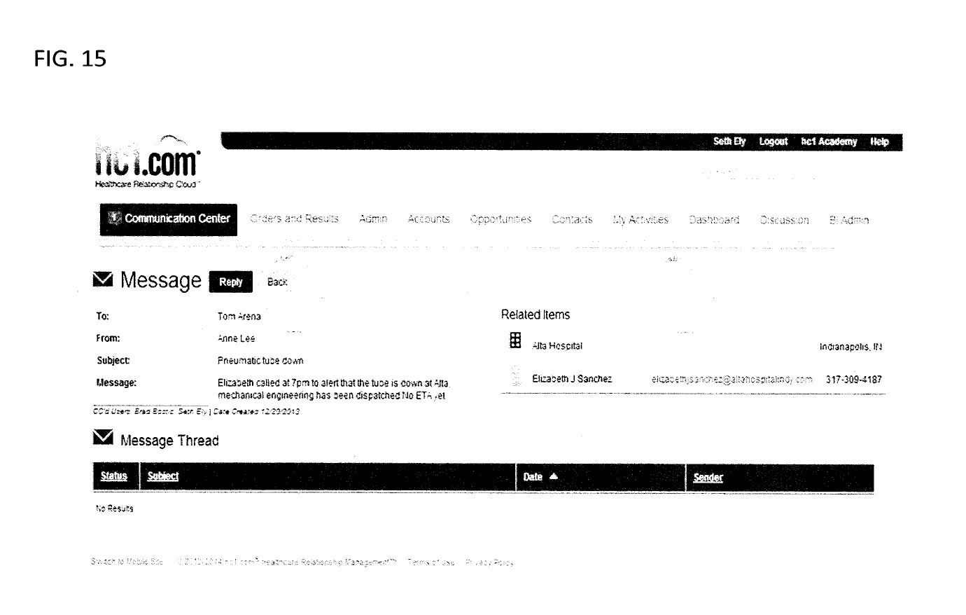

In step 242, the healthcare management system receives a communication request. In this step, a user identifies a problem area, desires to communicate some data to another user, or generally has a need to send a message referencing sensitive data within a system to another user. In such an embodiment, the user may access the communication portal and select an indication to send such a communication to another user. The portal may present the user with a graphical user interface for creating the message, such as, for example, the graphical user interface shown in FIG. 15. In such an embodiment, the portal may prompt the user to input a recipient, the subject of the message, and references to any data within the system to be included in the message. It should be appreciated that the healthcare relationship management system may be configured to present to the user an interface that provides a familiar user experience for sending communications, like an interface for sending email.

In step 244, the user selects to send the communication with the healthcare relationship management system. In such embodiments, the system is configured to create the communication for review by the associated recipient. In traditional communication systems, sending a communication to another user may utilize a communication transfer protocol to transmit the communication from one server to another server outside of the control of an organization, like sending an email. In such traditional systems, the communication may be created by a user and then transferred offsite or over a computer network to a third party system via SMTP or other transfer protocol. In some embodiments of the present disclosure, the communication, when sent by a user, is created within a database controlled by the system and, therefore, confined to an area controlled by the healthcare relationship management system at all times. By controlling the communication in this manner, the healthcare relationship management system can ensure that any sensitive information associated with the communication does not egress from the system itself.

For example, a business analyst for a hospital may desire to communicate a report of poorly performing data metrics with sensitive patient health information to a superior. In the traditional model, the business analyst may generate the report in his or her business analytics solution, save the report in a PDF, and then email the report to a superior. In the present disclosure through execution of the steps of the method 240, the business analyst may create a communication in step 242 identifying the intended recipient, reference the report generated by the healthcare relationship management system and then select to send the communication. Upon sending the communication, the healthcare relationship management system is configured to create a communication in step 244 through population of a record in a controlled database for the communication. In this example, the report is not saved as a PDF to the user's computer and then transferred over a computer network to an email server. Instead, the report is generated within a healthcare relationship management system, attached to a communication within the healthcare relationship management system, and the communication is created for review by the recipient—without any information ever leaving the control of the healthcare relationship management system.

It should be appreciated that this solution provides advantages over existing implementations by enabling an organization to freely communicate sensitive information (i.e. protected health information, confidential information, trade secrets, or the like) without the problems of data egress from the organization through uncontrolled mail servers, unencrypted email traffic, sensitive reports being stored on user computers, or otherwise. In the present disclosure, the systems enable free communication of such sensitive data through the confines of a healthcare relationship management system that is configured to ensure data is only viewable by parties with authorization to review the data. This seamless integration of authorization provides efficiencies for communication that are currently unavailable in the art.

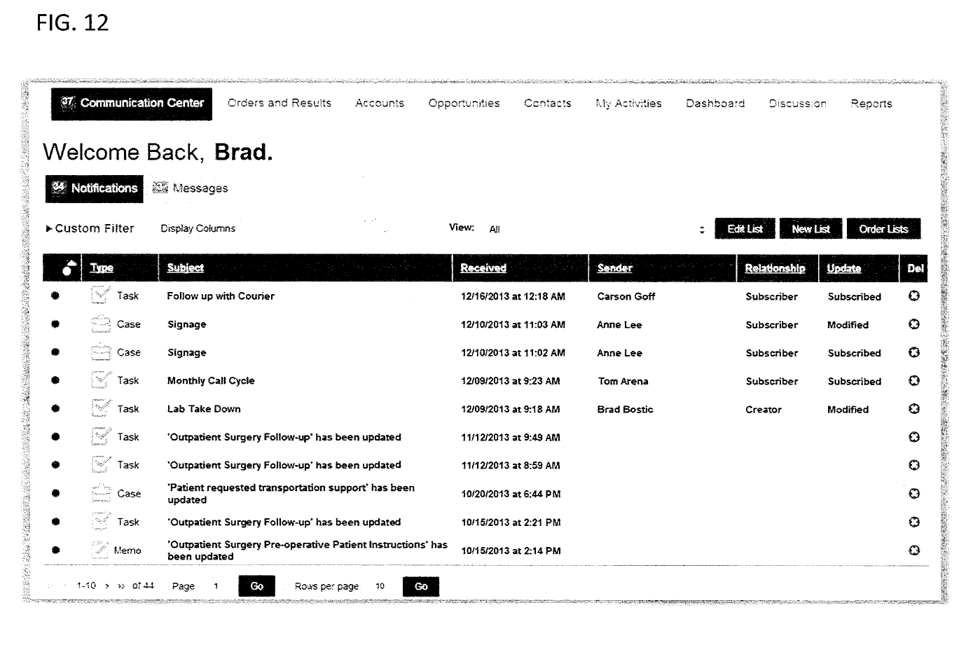

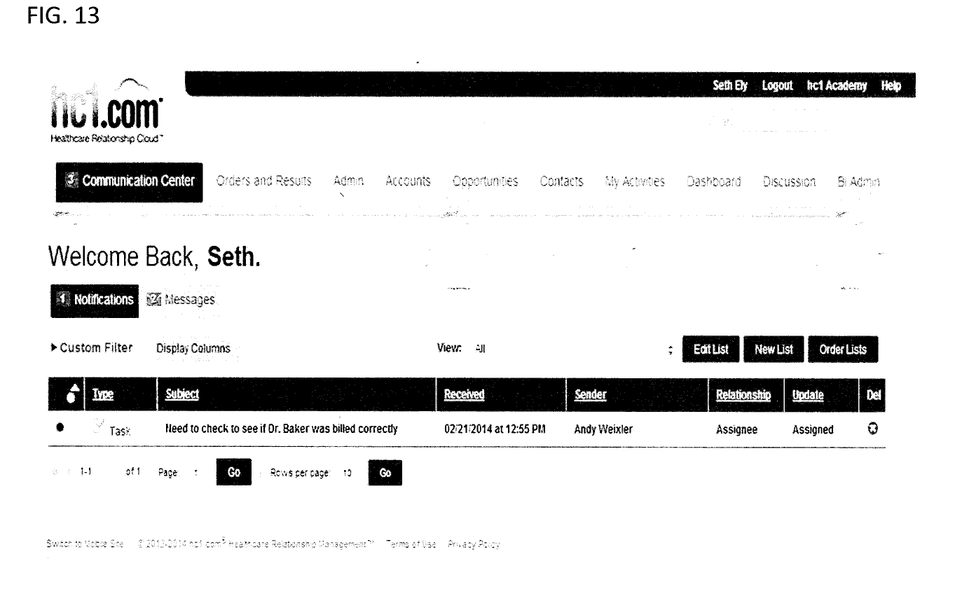

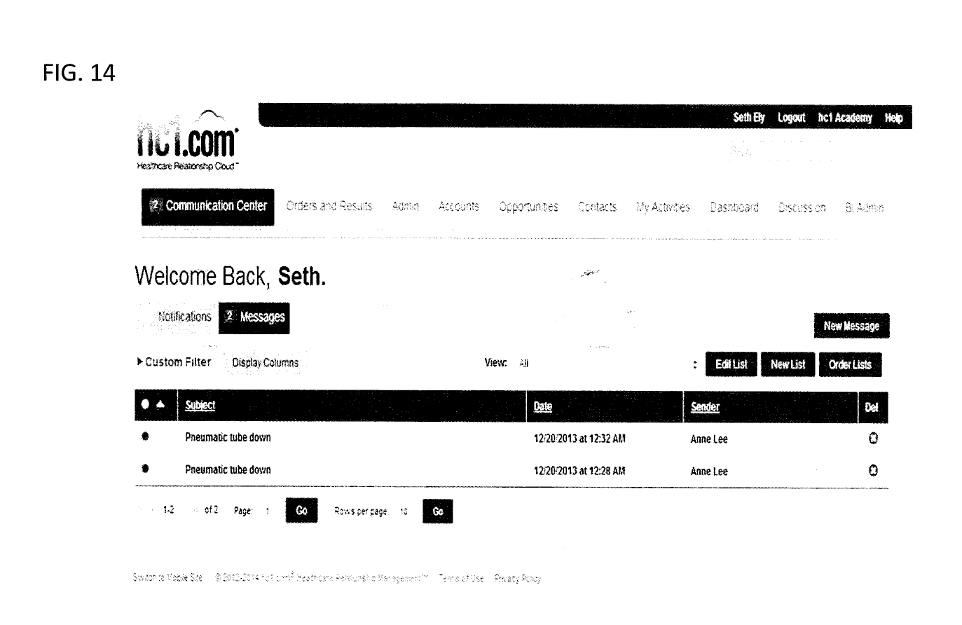

In at least one embodiment of the present disclosure, the method 240 includes receiving a communication retrieval request from the recipient in step 246. In such an embodiment, a user receiving a communication within a healthcare relationship management system may desire to receive the communication and click or otherwise interact with the healthcare relationship management system to obtain the contents of the communication. The healthcare relationship management system may generate a portal interface for the user to show all communications available for the user, such as, for example, the graphical user interfaces shown in FIG. 12, FIG. 13, and FIG. 14. In this view, the user may see all communications created for the user, the sender of each communication, the subject of each communication, the date of each communication, the type of communication, the relationship of the communication to the user, and other information. The graphical user interface may further be configured to enable the user to click on a communication to view its contents, delete a communication, reply to a communication, forward a communication, or otherwise interact with a communication.

In at least one embodiment of the present disclosure, after a user indicates a desire to open a communication through a portal, the user's authorization to view information contained within the communication is verified in step 248. In such an embodiment, the communication may include data categorized as sensitive for which a requisite access level is required. In such an embodiment, the user's role and node membership may be verified to determine whether the user has access to such data in step 248.

It should be appreciated that the user access controls based on role and node described in the methods 220 and 230 may be combined with generating and sending communications in the method 240 to enable the communication of information deemed sensitive or subject to privacy regulations within the healthcare relationship management system without needing to employ an additional layer of security. By utilizing the previous categorization of data within the system, assigned user roles, and assigned user nodes, the system may be configured to verify authorization at any point where a user attempts to access such sensitive data. For example, a user attempting to send a communication to another user may desire to include a reference to a table showing real-time data for the last ten purchased laboratory tests from a client. In this example, the sending user may be associated with a role and node providing authorization to the data included in the report. However, the receiving user may not be authorized to view such data and, upon attempting to view the report from the message within the healthcare relationship management system, the healthcare relationship management system may be configured to deny access to the receiving user and/or generate masked or malformed data to hide the unauthorized data.

In at least one embodiment of the present disclosure, the communication is transmitted to the user in step 250. In such an embodiment, a healthcare relationship management system may be configured to display the communication to the user in step 250 through a graphical user interface, such as, for example, the graphical user interface shown in FIG. 15. In such an embodiment, the communication may include the original message from the originating user and one or more references to stored data within the healthcare relationship management system.

In at least one embodiment of the present disclosure, the data referenced in a communication that, when opened by the user, may update based on real time or near real time data. In such embodiments, a user creates a communication in step 244 with references to reports or other data stored within a healthcare relationship management system at a certain time. At later time, in step 250, a recipient opens the communication. In some embodiments, upon sending a request to view the referenced data within the communication, the healthcare relationship management system is configured to pull real time or near real time data for display to the user. In such embodiments, the user is given an accurate and real time look into the data originally sent in the communication. It should be appreciated that by reviewing real time data within the communication, the recipient may be in a better position to react to the data to create actionable tasks for remediation of an identified problem from the data or otherwise.

For example, a user may identify within a healthcare relationship management system that an individual nurse is, on average, slow in responding to patient questions. To remediate this issue, the user may create a communication for a recipient with a reference to a report showing the average response time of the nurse over the last five days. Within the message, the user may include a request for the recipient to follow up with the nurse “if this is still a problem.” In this example, the recipient may view the communication at a time period after the communication is created for the recipient. At this time, when the recipient opens the communication and views the referenced report, the report may pull real time data for the nurse which purports to show that the nurse has been much quicker in responding to patient requests. In this example, then, the recipient may identify that this behavior is no longer an issue and choose not to react to the previously identified problem.

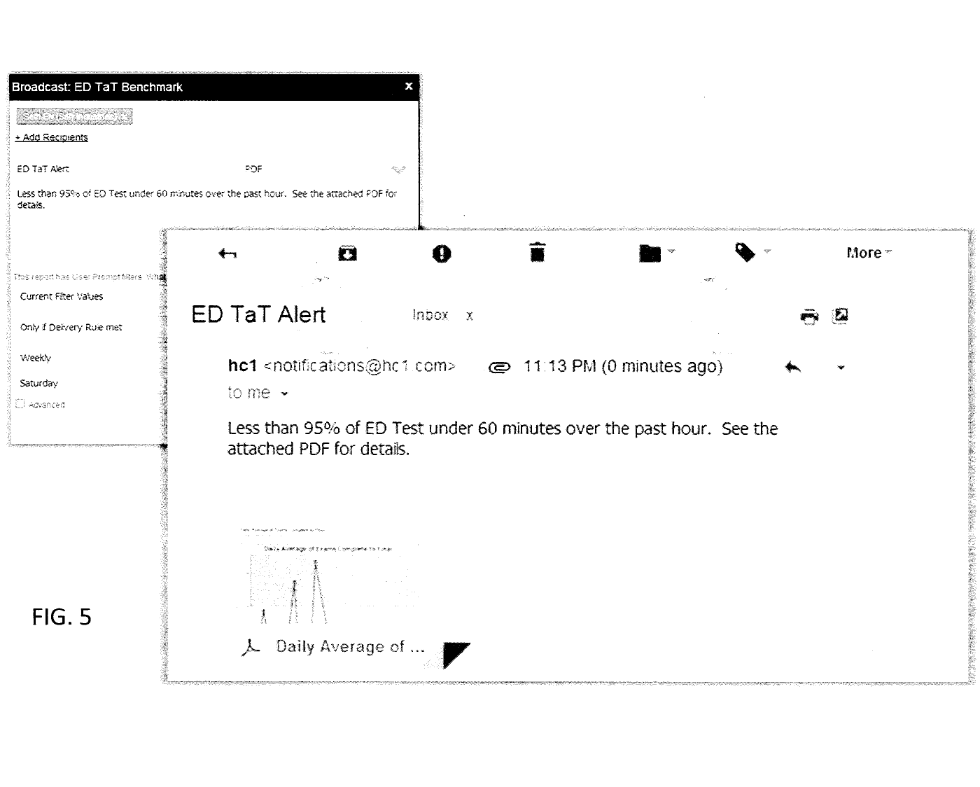

In at least one embodiment of the present disclosure, communications (or “alerts”) may be generated by a healthcare relationship management system for an individual user. In such an embodiment, a user may configure thresholds on attributes that are monitored in real-time by a healthcare relationship management system to generate alerts when such values go outside of the threshold. In such an embodiment, the alerts may be generated and flow through the communication stream discussed in the method 240. In some embodiments, such as, for example, as shown in FIG. 5, the notification may be sent to a user via email, SMS, social media message, MMS, Twitter direct message, or otherwise for immediate notification. In such embodiments, the alert will not include sensitive information and may direct a recipient to login to the healthcare relationship management system to view such sensitive information associated with the alert.

In at least one embodiment of the present disclosure, a recipient of a communication may create a task for remediation of an identified problem area within the communication in step 252. In such an embodiment, the task creates an actionable and accountable request for another user to review and/or remediate a problem identified within the task. The task may include, but is not required to include, referenced data within a healthcare relationship management system supporting the problem area associated with the task. The task may further include a description of the problem and a suggested timeline for resolution.

An example task is displayed in the graphical user interface displayed in FIG. 13. As shown in FIG. 13, a task was received for the user Seth on Feb. 21, 2014 from Andy Weixler requesting that Seth “[n]eed to check to see if Dr. Baker was billed correctly.” In this example, although not shown, the task may include a reference to data corresponding to Dr. Baker's last bill that, when opened by the user Seth, will pull the billing data directly from the healthcare relationship management system database.

Referring now to FIG. 2D, it is shown a method 260 for healthcare relationship management according to at least one embodiment of the present disclosure. As shown in FIG. 2D, the method 260 includes receiving a report request in step 262, retrieving active and warehoused health information in step 264, generating a business intelligence report in step 266, filtering the business intelligence report in step 268, receiving request to drill down into the business intelligence report in step 270, and generating an actionable data layer in step 272.

In at least one embodiment of the present disclosure, the method 260 includes receiving a request for a report in step 262. In such an embodiment, a healthcare relationship management system may present to a user a graphical user interface enabling a user to identify, customize, and generate business intelligence reports based on information known and/or stored by the healthcare relationship management system. In such an embodiment, the business intelligence reports may be pre-configured reports that may be generated against real time or near real time data (i.e. top sales of the month, turn-around time for the month, average turn-around time, and others). It should be appreciated that any report generated within the method 260 may be saved or otherwise configured to be easily reproduced at a later time as a pre-configured business intelligence report. It should be appreciated that the step 262, and other steps of the method 260, may be repeated as a user refines, filters, and otherwise manipulates a business intelligence report.

In at least one embodiment of the present disclosure, the method 260 includes retrieving active and warehoused health information in step 264. It should be appreciated that at least one advantage presented in the present disclosure is to present business intelligence reports with a combination of real time and warehoused data. In step 264, a healthcare relationship management system may be configured to pull data for a business intelligence report from an archive of information in a data warehouse in combination with real-time or near real-time data flowing to the healthcare relationship management system from third party resources and/or generated by the healthcare relationship management system.

In at least one embodiment of the present disclosure, the method 260 includes generating a business intelligence report. In such an embodiment, the request from the user in step 262 is combined with the retrieved active and data warehoused information in step 264 to generate a business intelligence report in a graphical user interface in step 266. In such an embodiment, the business intelligence report may be generated as a table, graph, or other filtered view into data housed within the healthcare relationship management system.

It should be appreciated that the business intelligence report may be generated through one or more business intelligence tools, such as, for example, Eclipse, Jaspersoft, Palo, ActiveReports, Informatica, Proclarity, SpagoBI, Microsoft Excel, or other business intelligence tools. It should further be appreciated that the business intelligence reports may be generated through proprietary means creating one or more views into the data retrieved in step 264. Using these tools or through proprietary means, a user may build a business intelligence report. In such an embodiment, a user may select any data fields known to a healthcare relationship management system to include in the report, a date window, one or more filters, and other information to generate the report.

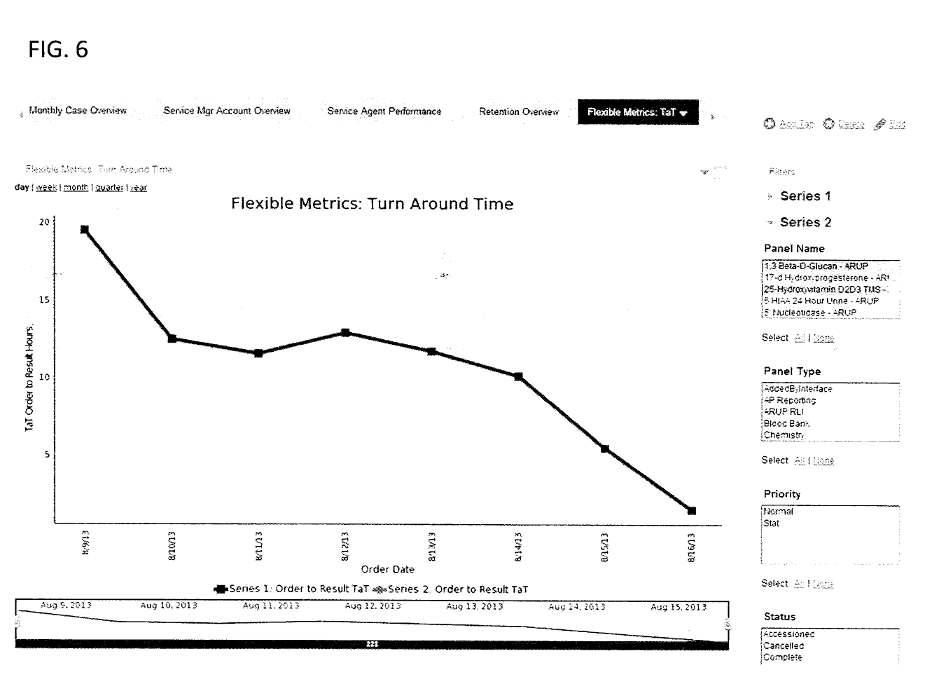

An example business intelligence report is shown in FIG. 6. As shown in FIG. 6, the business intelligence report is presented as a graphical user interface within a healthcare relationship management system. As shown in FIG. 6, the report is a graphical representation of information stored within the healthcare management system. In this example, the report is generated to display Turn-Around Time in hours over a period of days. In this example, the business intelligence report may be altered to show this data by the week, month, quarter, year, or other custom time window. In this example, the report may be further filtered to include additional information known to the healthcare relationship management system (i.e. priority, panel type, panel name, etc.) to enable a user of the report to quickly and efficiently identify relevant data.

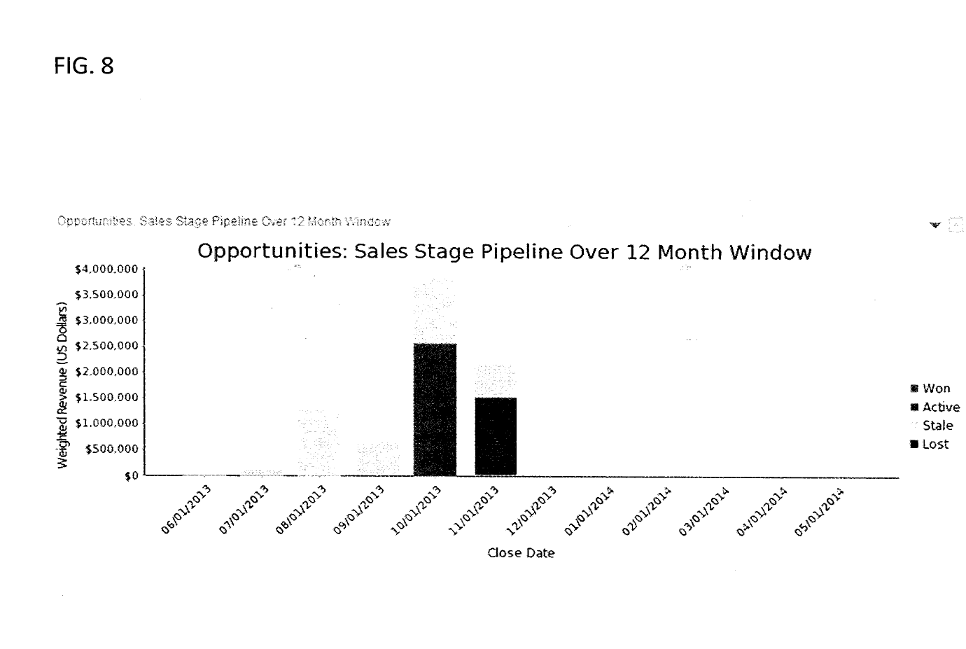

An example business intelligence report is shown in FIG. 8. As shown in FIG. 8, the business intelligence report provides an aggregate view of opportunities in a sales stage pipeline over a 12 month window. In this example, a user may have requested the business intelligence report from a preconfigured list of business intelligence reports to be generated against data warehoused information and real-time information within a healthcare relationship management system or the user may have built the business intelligence report from a set of fields to include, date window, and other options.

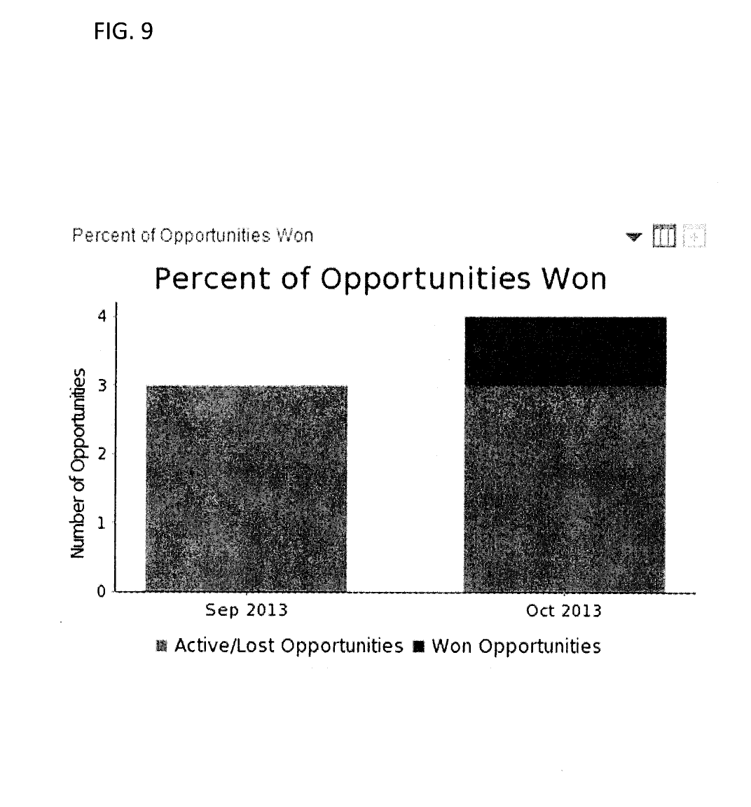

An example of a business intelligence report combining active and data warehoused data is shown in FIG. 9. As shown in FIG. 9, a business intelligence report is generated to display the percent of opportunities won in the months of September and October. In this example, if the report is being generated in October 2013, the information obtained to generate this business intelligence report is housed in a data warehouse, archived for the months of September and October, and may be stored in an active database for the current month of October. In this example, in the step 264, the healthcare relationship management system may pull data from the data warehouse for the month of September and combine this data with active data pulled from an active database for the month of October to present the business intelligence report shown in FIG. 9.

In at least one embodiment of the present disclosure, the method 260 includes filtering a business intelligence report in step 268. In such an embodiment, a user may select aggregated information presented in a business intelligence report to filter and/or alter the business intelligence report to present different data. A healthcare relationship management system presenting the business intelligence report may include a graphical user interface enabling the user to select one or more data record types, attributes, date ranges, or other options in a drop-box box, radio buttons, multi-selectable box, or other web component to enable the user to filter the business intelligence report. Upon receiving the user's filtering requests, the healthcare relationship management system may regenerate the business intelligence report with the filtering options. It should be appreciated that to regenerate the business intelligence report may be performed by repeating steps 262, 264 and 266 with the filtering options referenced in the receive report request step 262.

In at least one embodiment of the present disclosure, the user access controls discussed herein are applied to data presented in the business intelligence report. As discussed herein, a user that is a member of one or more roles and assigned to one or more nodes may be authorized to view types of data based on role membership and records of data based on node assignment. In such an embodiment, when presenting the business' intelligence report to the user in step 266 through the healthcare relationship management system, the data presented may be evaluated against the user's role membership and node assignment to determine whether to display the data requested, mask the data requested, or deny access to the data requested.

In at least one embodiment of the present disclosure, the method 260 includes receiving a request to drill down into a report in step 270. In such an embodiment, a graphical user interface displaying a business intelligence report is configured to enable a user to click onto any information presented in the report to find more information related to what is presented. For example, if an aggregate data element is presented (i.e. total turnaround time for orders in a month), the user may drill down into this information to see each individual data element used to make up the aggregate number (i.e. each order and its associated information). Similar to filtering a business intelligence report, drilling down into a business intelligence may be treated as generating a new business intelligence report, such that the steps 262, 254, and 266 may be generated to produce the drilled down report. It should be appreciated, then, that a user may drill down into a business intelligence report down to the individual data elements stored within the healthcare management system. It should further be appreciated that this structure enables a user to go from an aggregate set of data to individual data records efficiently.

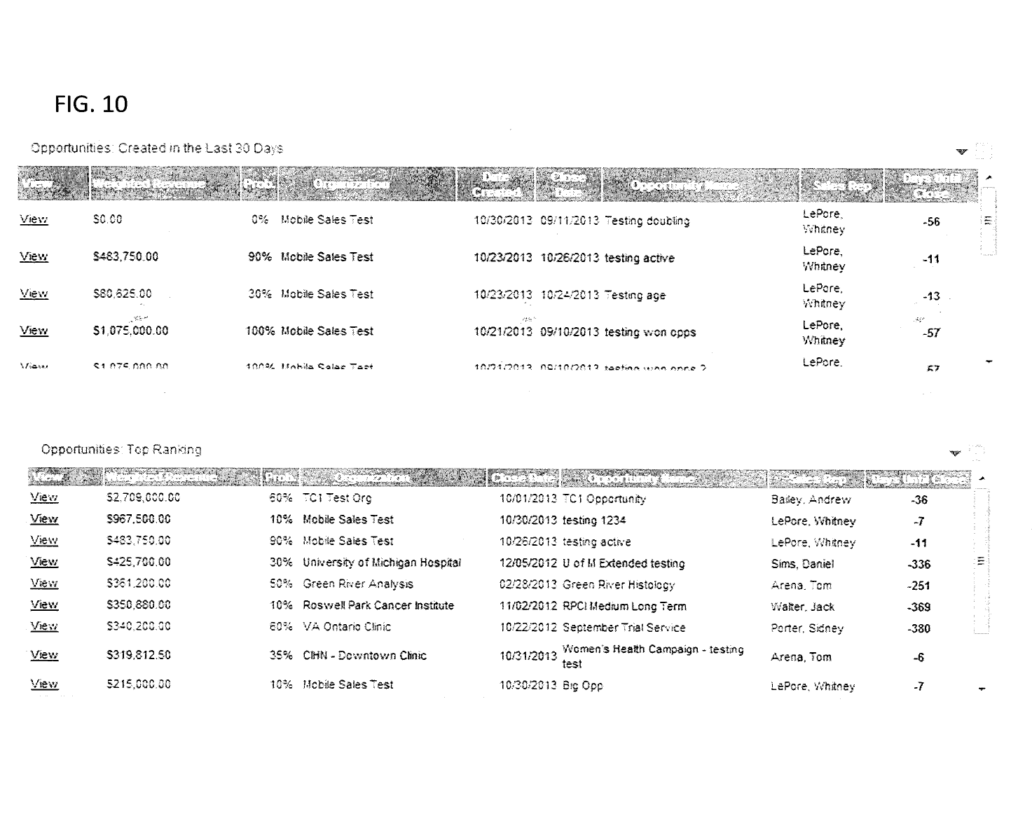

As discussed previously, both FIG. 8 and FIG. 9 present an example business intelligence report generated through execution of the method 260. In these examples, a user may be presented with an option to drill down into individual data elements to obtain more information, such as, for example, the individual data element views presented in FIG. 10. To drill down into the reports, a user may click on any individual date window or aggregate representation of information within the reports.

For example, a user may generate a business intelligence report for the total turnaround time of laboratory tests ordered within a calendar year, broken down individually by month. In this example, the user may select any individual month to drill down the business intelligence report to display total turnaround time for laboratory tests within a month broken down by week. In this example, the user may further drill down into the weekly business intelligence report by identifying an individual week to generate a business intelligence report that displays total turnaround time for individual laboratory tests broken down by day in the aggregate. The user, then, may further drill down into an individual day to generate a business intelligence report that generates the individual data elements used in the aggregate representation by day. It should be appreciated, of course, that this is merely one example and that other options to drill down information by time, order, region, or other variable are available. For example, as discussed above, the business intelligence report by day may be further drilled down to generate total turnaround time for laboratory tests ordered by hour, etc.

In at least one embodiment of the present disclosure, the method 260 includes generating an actionable data layer in step 272. In such an embodiment, a healthcare relationship management system may be configured to enable a user to drill down into individual data elements and present options to the user to create tasks directly on any individual data elements or aggregated data elements. In such an embodiment, the user may indicate a desire to create a task from any individual data element or a grouping of data elements for actionable and accountable remediation. In such an embodiment, the user may assign a due date to the task, set a status, create a subject and description, assign the task to an individual user, set a priority and category, and carbon copy other users of the healthcare relationship management system for the task.

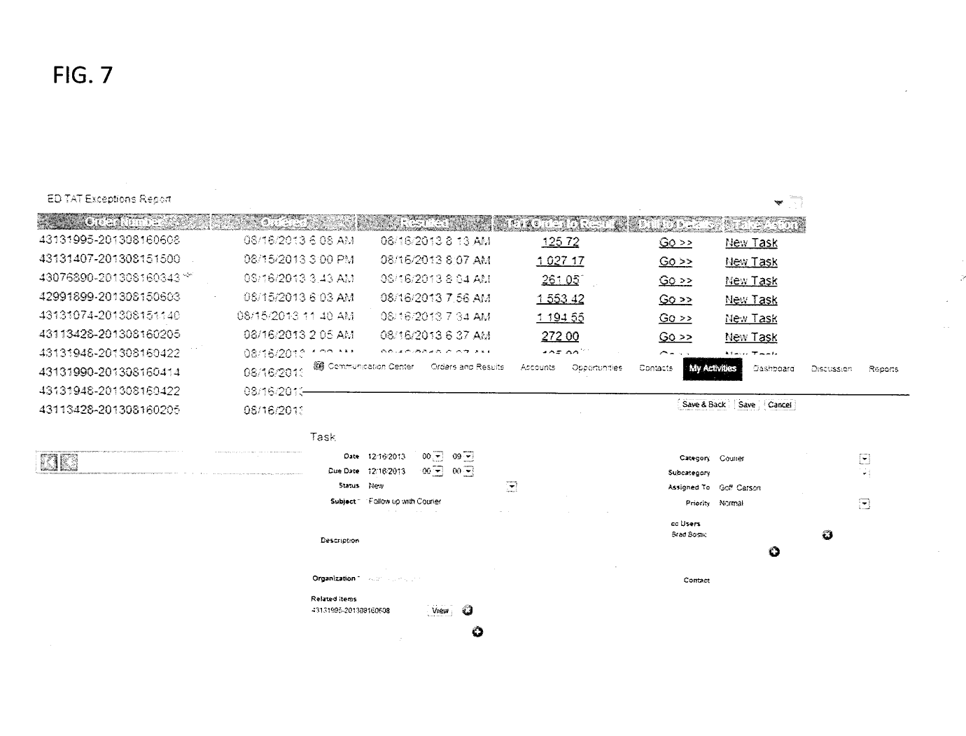

An example business intelligence report with an actionable task being created is shown in FIG. 7. As shown in FIG. 7, the business intelligence report is directed to laboratory test turnaround time exceptions. In this example, the turnaround time exceptions are related to a preconfigured threshold of turnaround time as an exception. In this example, a turnaround time of 125.72, 1,027.17, 261.05 and 1,533.42 hours are each over the preconfigured threshold. As shown in FIG. 7, the individual data elements each include an order number, an ordered data, a result date, a calculated turnaround time, an option to drill into further details concerning the data element, and an opportunity to create a task for each data element.

As shown in FIG. 7, the create task option has been selected to provide the popup shown. As shown in FIG. 7, the popup includes order 43131995-201308160608 as a related item which corresponds to the first entry in the business intelligence report. In this example, then, the user has indicated a desire to create a new task from the first order presented in the turnaround time exceptions report. In this example, the user has entered a subject of “Follow up with Courier”, set a same-day due date for the task, assigned the task to an individual user in the system—Goff, Carson and carbon copied a manager for the task—Brad Bostic. In this example, when the task is created, the task will be placed into the queue of tasks^{.} for Goff, Carson for remediation. In the event that Goff, Carson views the task, as discussed previously, Goff, Carson will have immediate access to the related item tied to the task to find more information and, presumably, which courier to contact to determine what happened in this instance.

It should be appreciated that each layer of a business intelligence report may be further drilled into in order to obtain more detailed information. For example, FIG. 6 displays a Flexible Metrics, Turn Around Time business intelligence report which provides aggregated information concerning the total turnaround time for a few days in August 2013. In this example, in the event that the user drills down into any individual day within the business intelligence report, the user may be presented with individual records which comprise the aggregated information, such as, for example, in a graphical user interface similar to one shown in FIG. 7. As shown in FIG. 7, the user may then further drill into an individual data element to identify more information concerning a specific order number. It should be appreciated that giving a user a direct opportunity to drill down into individual data elements from an aggregate business intelligence provides an efficient way to view healthcare relationship information to improve management, find problems, determine solutions to said problems, and assign such solutions to individual resources.

In at least one embodiment of the present disclosure, the healthcare relationship management system may be configured to display entity specific names for variables, attributes, data types, and other information with the system. In such an embodiment, an entity may desire to name specific data attributes, business intelligence report types, and other items in specific manners outside of the standard naming conventions deployed. In such an embodiment, the healthcare management system may be configured to use an individualized set of naming conventions for a specific entity.

In some embodiments, the healthcare management system may enable such individual naming conventions by assigning variables at the presentation or application layer for each data element, attribute type, or other information set for which non-standard naming conventions are to be used. Then, the healthcare management system may query a database or document where the individualized naming conventions are stored to fill the variables appropriately for the specific entity. It should be appreciated that individual naming conventions may be configured to only display such unique naming conventions for users affiliated with organization where such naming conventions are deployed. For example, if health organization A and health organization B each collectively use a healthcare relationship management system and healthcare organization A utilizes individualized naming conventions, then users affiliated with healthcare organization A will be presented with the individualized naming conventions whereas users affiliated with healthcare organization B will be presented with standard naming conventions at the presentation layer. It should be appreciated that the back-end database infrastructure need not be individualized for these naming conventions and that the presentation layer or application layer may make the appropriate translation to individualized naming conventions as appropriate.

For example, a standard healthcare relationship management naming convention for the time it takes to fill a proscription may be “fill time.” In this example, a healthcare organization that fills proscriptions may have an individualized naming convention where the standard “fill time” is named “close time.” In this example, a healthcare management system may use a variable for the presentation of “fill time” within a style sheet or otherwise that queries a database or document to retrieve the appropriate naming convention for the entity during presentation. In this example, users logging in and associated with the entity will display “close time” rather than “fill time” through the healthcare relationship management system. In this example, users not affiliated with the entity would still retrieve the standard “fill time” moniker.

Referring now to FIG. 2E, it is shown a method 280 for healthcare relationship management. As shown in FIG. 2E, the method 280 includes receiving a communication request in step 282, creating a communication in step 284, associating the communication in step 285, receiving a communication retrieval request in step 286, verifying user access in step 288, transmitting the communication in step 280, and creating an actionable task in step 282.

In at least one embodiment of the present disclosure, the method 280 includes receiving a communication request in step 282. In such an embodiment, a healthcare relationship management system is configured to present a user with a portal for secure and data-rich communication within the system. The communication portal enables users of the healthcare relationship management system to send communications to other users or themselves with references to information stored within the system. When rendering the communication for the recipient, the healthcare relationship management system verifies whether the recipient is authorized to view data referenced in the communication and may apply masking techniques or otherwise to avoid presenting the data to an unauthorized user.

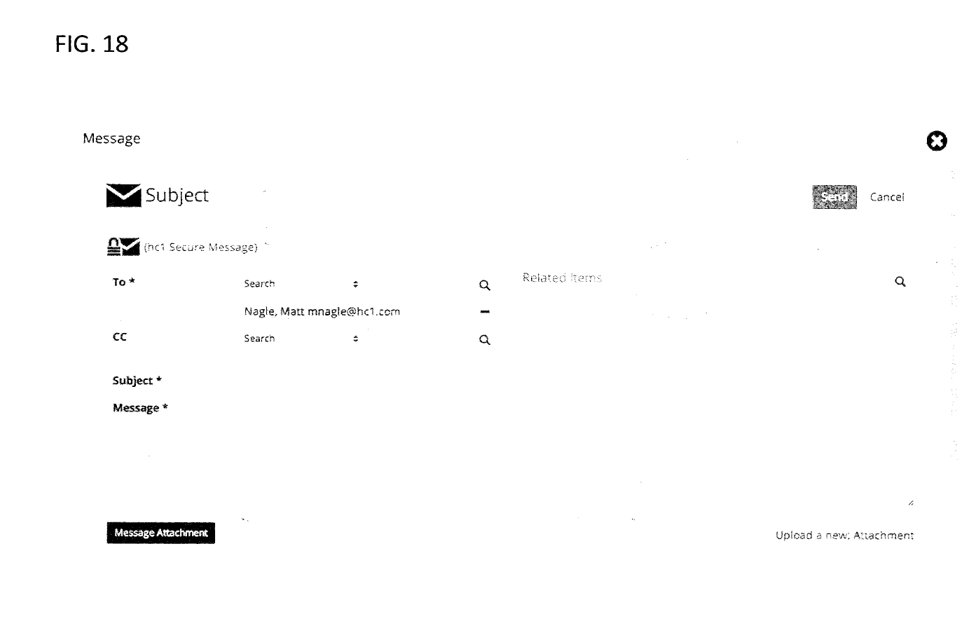

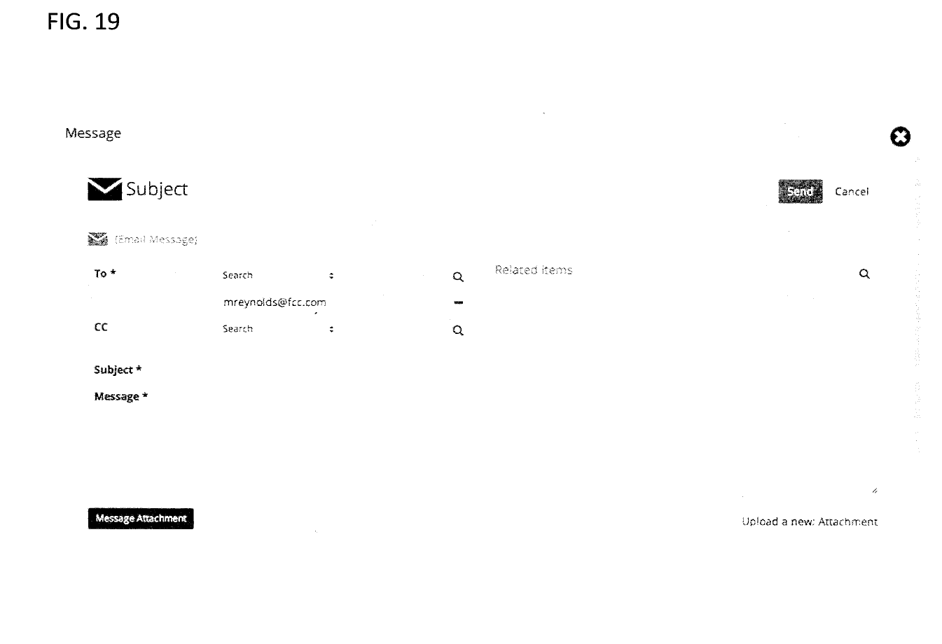

In some embodiments, in step 282, the healthcare relationship management system receives a communication request. In this step, a user identifies a problem area, desires to communicate some data to another user, or generally has a need to send a message referencing sensitive data within a system to another user. In such an embodiment, the user may access the communication portal and select an indication to send such a communication to another user. FIGS. 18 and 19 display examples of communication creation requests displayed in a healthcare relationship management system. In FIG. 18, the communication requested to be created is associated with a user record of the healthcare relationship management system such that any communication generated would stay within the healthcare relationship management system and, accordingly, remain secure. It should be appreciated, though, that a healthcare relationship management system may send communication to external sources not authorized to view and access protected health information (PHI) and such an example is shown in FIG. 19. Of course, a communication sent to a third party not authorized to view and access PHI through the healthcare relationship management system would adhere to the appropriate access control properties configured within the healthcare relationship management system to protect such information and, therefore, the communication originating from the healthcare relationship management system would only include non-PHI data.

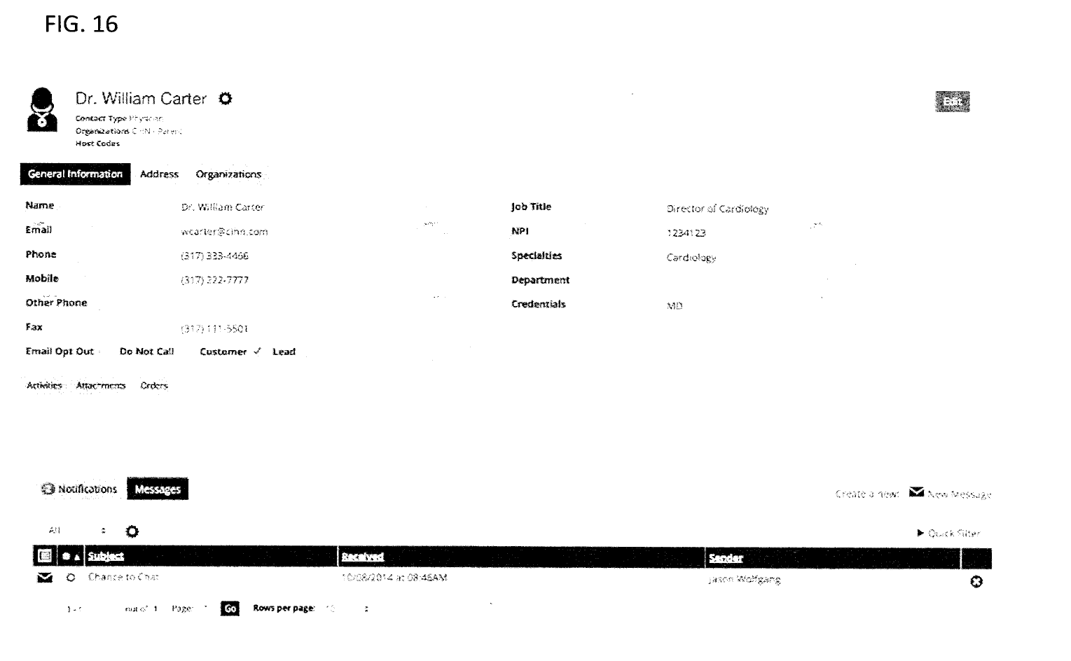

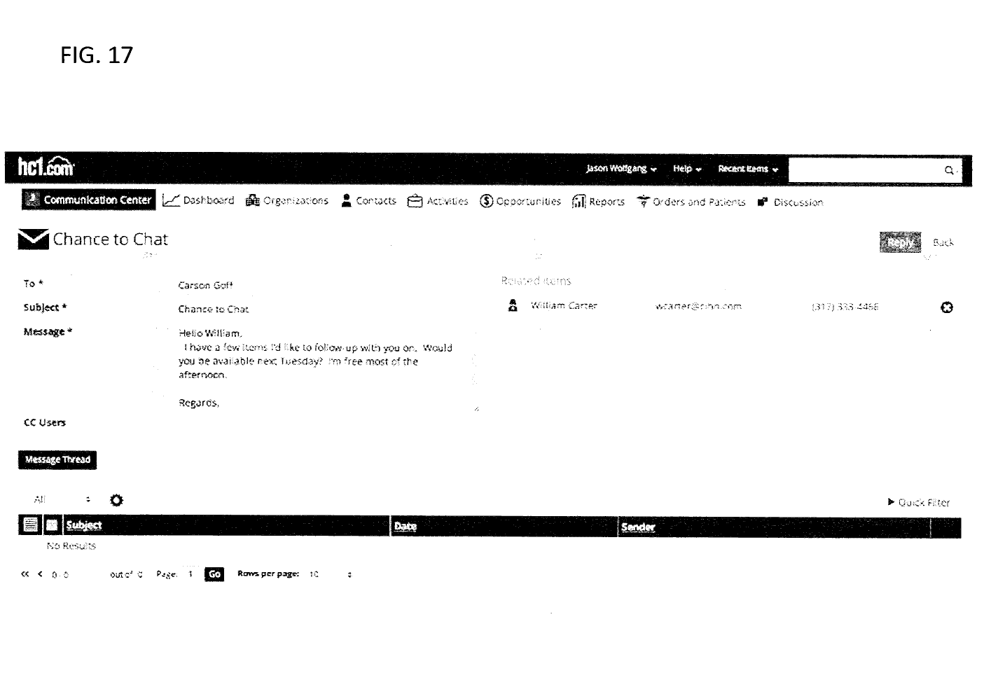

The portal may present the user with a graphical user interface for creating the message, such as, for example, the graphical user interface shown in FIG. 12. In such an embodiment, the portal may prompt the user to input a recipient, the subject of the message, and references to any data within the system to be included in or associated with the message. It should be appreciated that the healthcare relationship management system may be configured to present to the user an interface that provides a familiar user experience for sending communications, like an interface for sending email, such as, for example, the graphical user interfaces displayed in FIGS. 14-18. Of course, as shown in FIGS. 15 and 17, the healthcare relationship management system may display related items to the communication being viewed. For example, as shown in FIG. 15, “Elizabeth J Sanchez” is a related item to the communication being discussed because the message discusses a phone call from Elizabeth. In this example, a user of the healthcare relationship management system added the Elizabeth J Sanchez to the communication as a related item.

In step 284, the user selects to send the request, which causes a communication to be created within the healthcare relationship management system. In some embodiments, the system is configured to create the communication for review by the associated recipient. In traditional communication systems, sending a communication to another user may utilize a communication transfer protocol to transmit the communication from one server to another server outside of the control of an organization, like sending an email. In such traditional systems, the communication may be created by a user and then transferred offsite or over a computer network to a third party system via SMTP or other transfer protocol. In some embodiments of the present disclosure, the communication, when sent by a user, is created within a database controlled by the system and, therefore, confined to an area controlled by the healthcare relationship management system at all times. By controlling the communication in this manner, the healthcare relationship management system can ensure that any sensitive information associated with the communication does not egress from the system itself

For example, a business analyst for a hospital may desire to communicate a report of poorly performing data metrics with sensitive PHI to a superior. In the traditional model, the business analyst may generate the report in his or her business analytics solution, save the report in a PDF, and then email the report to a superior. In the present disclosure through execution of the steps of the method 280, the business analyst may create a communication in step 282 identifying the intended recipient, reference the report generated by the healthcare relationship management system and then select to send the communication. Upon sending the communication, the healthcare relationship management system is configured to create a communication in step 284 through population of a record in a controlled database for the communication. In this example, the report is not saved as a PDF to the user's computer and then transferred over a computer network to an email server. Instead, the report is generated within a healthcare relationship management system, attached to a communication within the healthcare relationship management system, and the communication is created for review by the recipient—without any information ever leaving the control of the healthcare relationship management system.

In some embodiments, in step 282, an external communication is transmitted to the healthcare relationship management system. In such embodiments, the external communication may be an email, text message, social media communication, or other electronic communication. In such embodiments, the external communication includes one or more identifiers associated with records, tasks, or users of the healthcare relationship management system. The one or more records may be native to the type of external communication transmitted (i.e. email address, SMS number) or may be inserted into the external communication for association. In the latter example, the one or more identifiers may include reserved characters or keywords to enable the healthcare relationship management system to recognize the one or more identifiers within the communication. For example, an email transmitted to a healthcare relationship management system may include the identifier “[user:regineldn],” where the ‘[‘and’]’ characters are reserved for recognition that the “user:regineldn” identifier is included in the communication. In this example, the healthcare relationship management system may use the identifier for association in later steps of the method 280.

In another example, the one or more identifiers may be native to the external communication. For example, an email address (i.e. regineldn@hcl.com) is included in the header of an email transmitted to the healthcare relationship management system. In this example, the healthcare relationship management system may be configured to utilize at least portions of the contents of the email header as an identifier. It should be appreciated that the native information which may be used as identifiers for the healthcare relationship management system are not limited to an email address. Of course, other infoimation may be used, like Subject, From, To, Date, phone number, and any information contained within the header or other native construct of an external communication.

In some embodiments, in step 284, an external communication is used to create a communication within the healthcare relationship management system. In such embodiments, the external communication is imported or used as input to a communication within the healthcare relationship management system.

It should be appreciated that this solution provides advantages over existing implementations by enabling an organization to freely communicate sensitive information (i.e. PHI, confidential information, trade secrets, or the like) without the problems of data egress from the organization through uncontrolled mail servers, unencrypted email traffic, sensitive reports being stored on user computers, or otherwise. In the present disclosure, the systems enable free communication of such sensitive data through the confines of a healthcare relationship management system that is configured to ensure data is only viewable by parties with authorization to review the data. This seamless integration of authorization provides efficiencies for communication that are currently unavailable in the art.

In at least one embodiment of the present disclosure, the method 280 includes associating a communication with one or more users in step 285. In such an embodiment, a communication created within the healthcare relationship management system may be associated with one or more users to efficiently categorize information and assist users in quickly finding relevant communications for review. In some embodiments, this step may be performed automatically by the healthcare relationship management system based on one or more identifiers within the communication, such as, for example, email address, identifiers defined by reserved characters, or other information.

For example, an external communication is sent to a healthcare relationship management system which is imported as a communication. In this example, the external communication includes the identifier regineldn@hcl.com by specifying that identifier within the body of the external communication offset by reserved characters. In this example, the healthcare relationship management system locates a record within a database or other repository which maps to regineldn@hcl.com, such as user record Regineld N. In the association step 285, the healthcare relationship management system associates the newly created communication with the Regineld N user record. When displaying the communication individually, the healthcare relationship management system will display the Regineld N user record in proximity to the communication to enable efficient retrieval of information for this user when viewing the communication. FIGS. 8 and 9 display user records that may be associated with such communications.

In at least one embodiment of the present disclosure, the method 280 includes receiving a communication retrieval request from the recipient in step 286. In such an embodiment, a user receiving a communication within a healthcare relationship management system may desire to receive the communication and click or otherwise interact with the healthcare relationship management system to obtain the contents of the communication. The healthcare relationship management system may generate a portal interface for the user to show all communications available for the user. In this view, the user may see all communications created for the user, the sender of each communication, the subject of each communication, the date of each communication, the type of communication, the reltionship of the communication to the user, and other information. The graphical user interface may further be configured to enable the user to click on a communication to view its contents, delete a communication, reply to a communication, forward a communication, or otherwise interact with a communication.

In at least one embodiment of the present disclosure, after a user indicates a desire to open a communication through a portal, the user's authorization to view information contained within the communication is verified in step 288. In such, an embodiment, the communication may include data categorized as sensitive for which a requisite aecess level is required. In such an embodiment, the user's role and node membership may be verified to determine whether the user has access to such data in step 288.

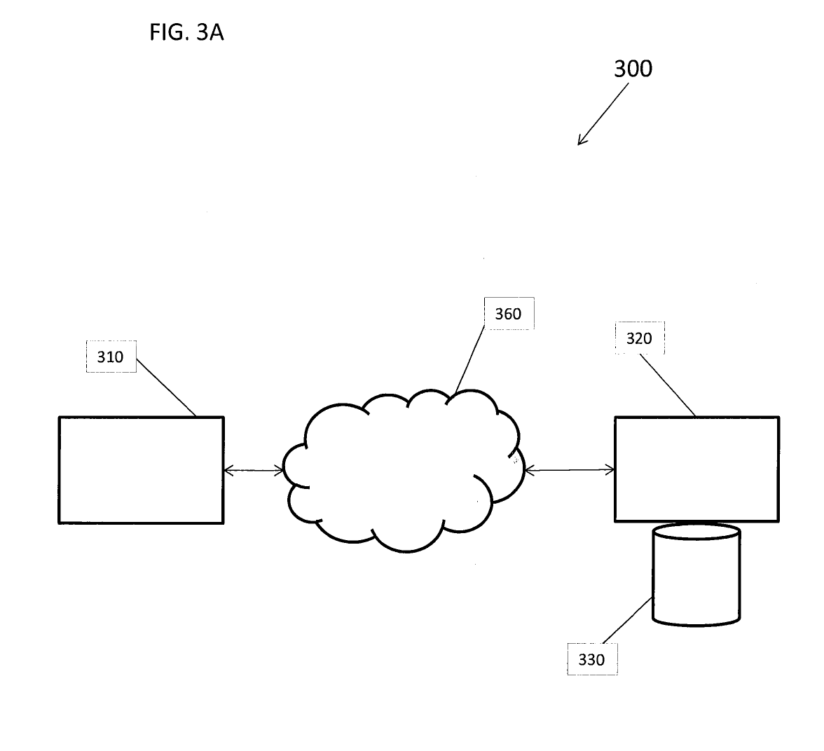

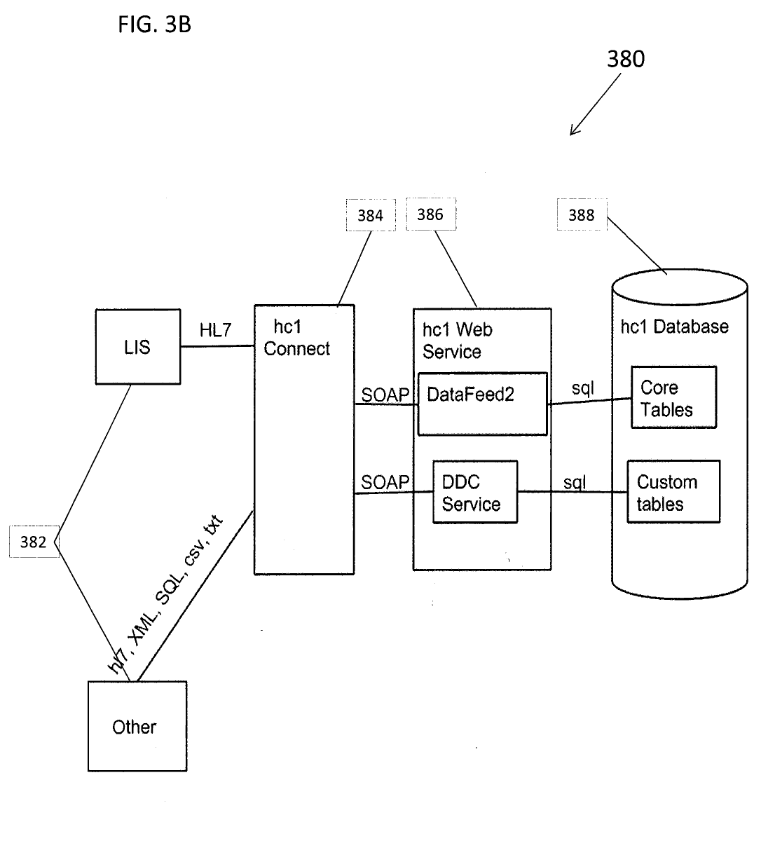

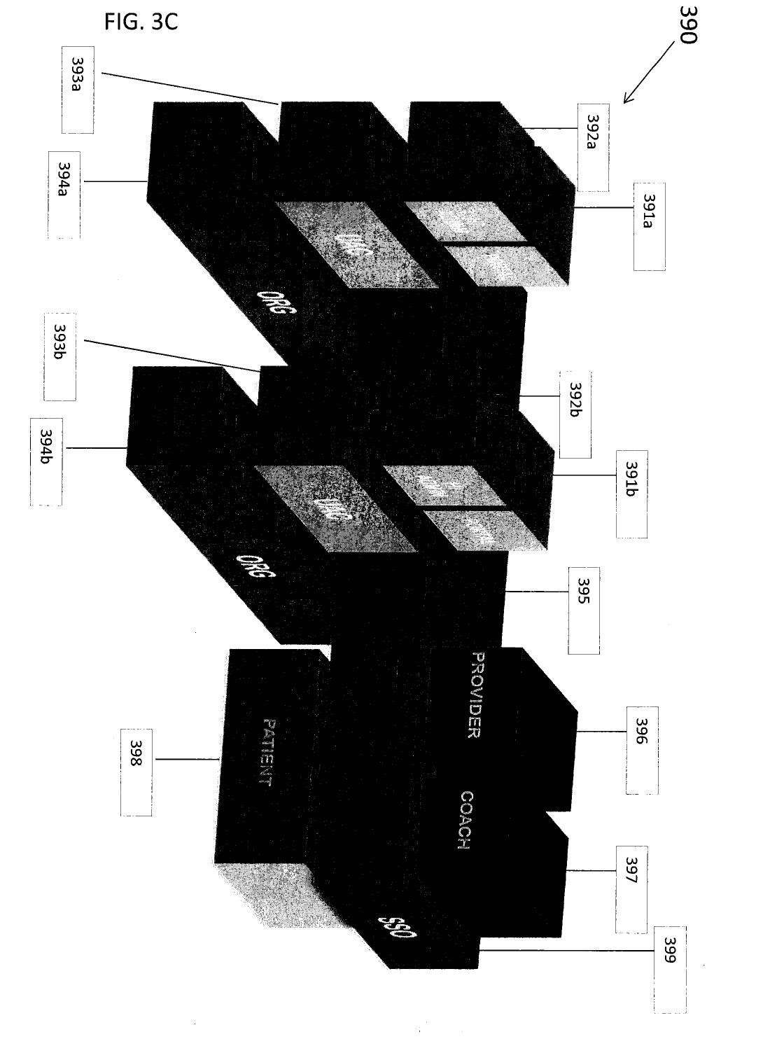

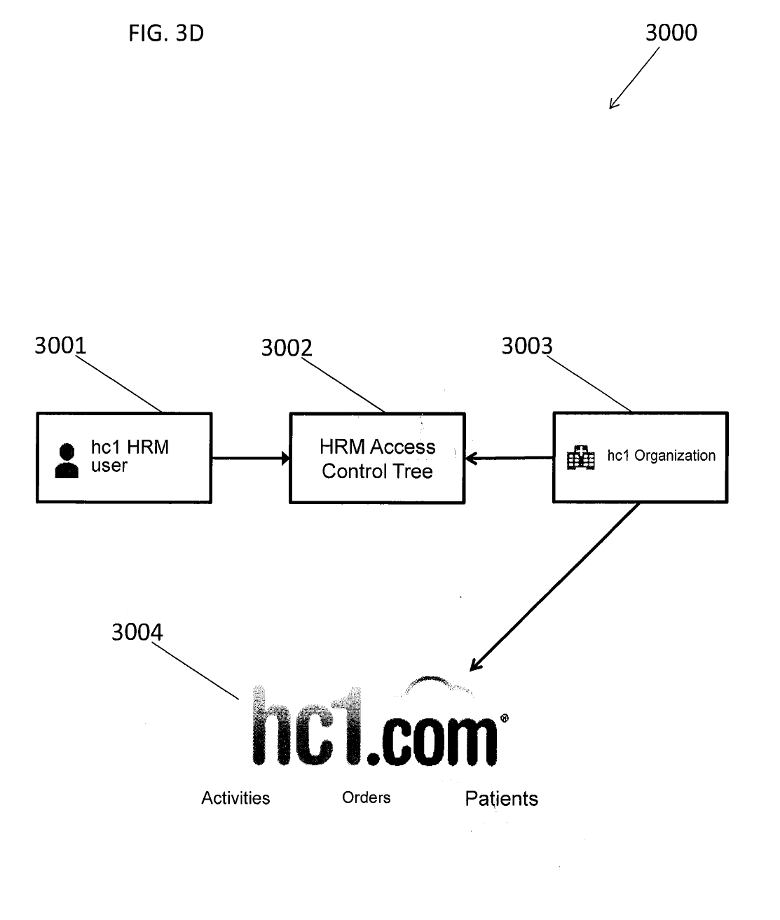

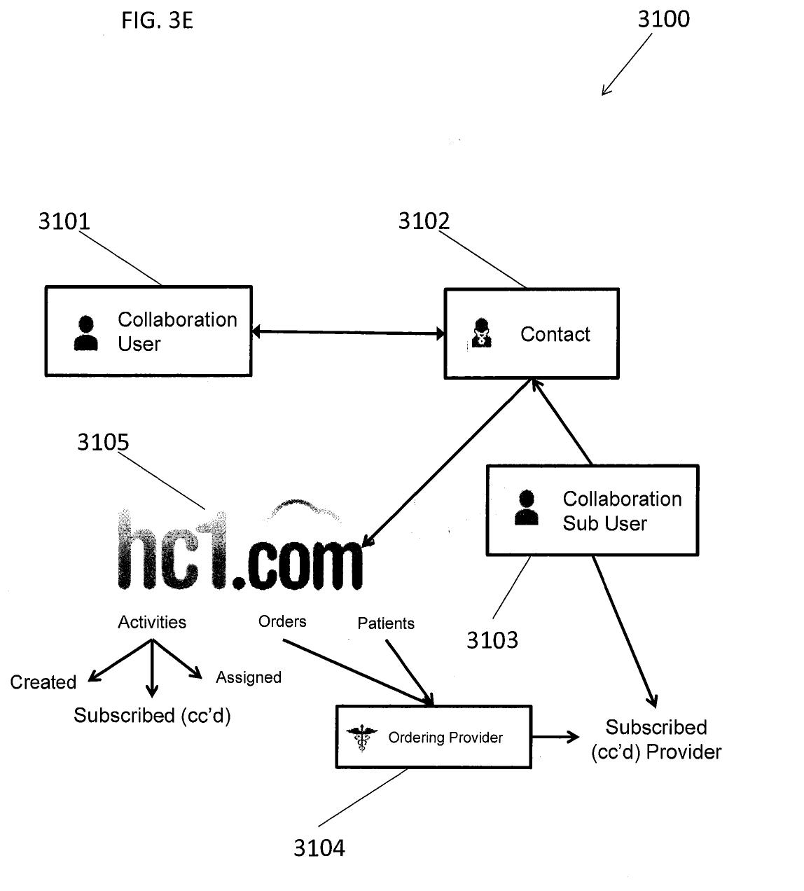

It should be appreciated that the user access controls based on role and node (as detailed in FIG. 3C and system 390) may be combined with generating and sending communications in the method 280 to enable the communication of information deemed sensitive or subject to privacy regulations within the healthcare relationship management system without needing to employ an additional layer of security. By utilizing the previous categorization of data within the system, assigned user roles, and assigned user nodes, the system may be configured to verify authorization at any point where a user attempts to access such sensitive data. For example, a user attempting to send a communication to another user may desire to include a reference to a table showing real-time data for the last ten purchased laboratory tests from a client. In this example, the sending user may be associated with a role and node providing authorization to the data included in the report. However, the receiving user may not be authorized to view such data and, upon attempting to view the report from the message within the healthcare relationship management system, the healthcare relationship management system may be configured to deny access to the receiving user and/or generate masked or malformed data to hide the unauthorized data.

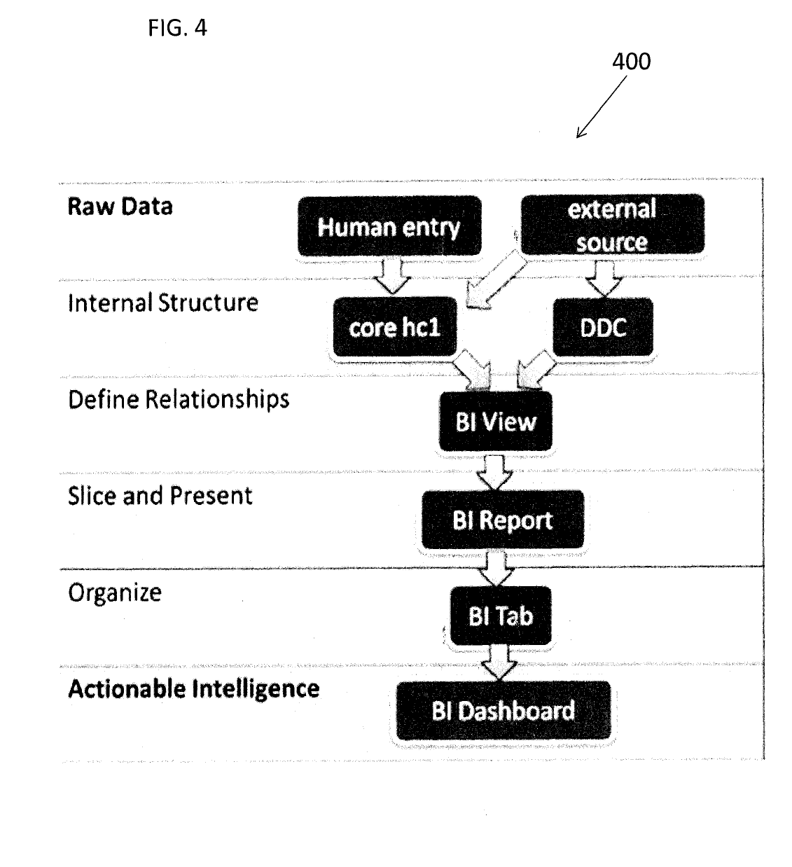

In at least one embodiment of the present disclosure, the communication is transmitted to the user in step 290. In such an embodiment, a healthcare relationship management system may be configured to display the communication to the user in step 290 through a graphical user interface, such as, for example, the graphical user interface shown in FIG. 4. In such an embodiment, the communication may include the original message from the originating user and one or more references to stored data within the healthcare relationship management system, such as, for example, information associated with the communication in step 285.

In at least one embodiment of the present disclosure, the data referenced in a communication that, when opened by the user, may update based on real-time or near real-time data. In such embodiments, a user creates a communication in step 284 with references to reports or other data stored within a healthcare relationship management system at a certain time or information is associated with the communication automatically in step 285 based on one or more identifiers within the communication. At a later time, in step 290, a recipient opens the communication. In some embodiments, upon sending a request to view the referenced data within the communication, the healthcare relationship management system is configured to receive real-time or near real-time data for display to the user. In such embodiments, the user is given an accurate and real-time look into the data originally sent in the communication and also may view the associated information in proximity to the communication. It should be appreciated that by reviewing real-time data and associated information within or next to the communication, the recipient may be in a better position to react to the data to create actionable tasks for remediation of an identified problem from the data or otherwise.

For example, a user may identify within a healthcare relationship management system that an individual nurse is, on average, slow in responding to patient questions. To remediate this issue, the user may create a communication for a recipient with a reference to a report showing the average response time of the nurse over the last five days. Within the message, the user may include a request for the recipient to follow up with the nurse “if this is still a problem.” In this example, the recipient may view the communication at a time period after the communication is created for the recipient. At this time, when the recipient opens the communication and views the referenced report, the report may pull real-time data for the nurse which purports to show that the nurse has been much quicker in responding to patient requests. In this example, then, the recipient may identify that this'behavior is no longer an issue and choose not to react to the previously identified problem.

In at least one embodiment of the present disclosure, communications (or “alerts”) may be generated by a healthcare relationship management system for an individual user. In such an embodiment, a user may configure thresholds on attributes that are monitored in real-time by a healthcare relationship management system to generate alerts when such values go outside of the threshold. In such an embodiment, the alerts may be generated and flow through the communication stream discussed in the method 280. In some embodiments, such as, for example, the notification may be sent to a user via email, SMS, social media message, MMS, Twitter direct message, or otherwise for immediate notification. In such embodiments, the alert will not include sensitive information and may direct a recipient to login to the healthcare relationship management system to view such sensitive information associated with the alert.

In at least one embodiment of the present disclosure, a recipient of a communication may create a task for remediation of an identified problem area within the communication in step 292. In such an embodiment, the task creates an actionable and accountable request for another user to review and/or remediate a problem identified within the task. The task may include, but is not required to include, referenced data within a healthcare relationship management system supporting the problem area associated with the task. The task may further include a description of the problem and a suggested timeline for resolution.

An example task is displayed in the graphical user interface displayed in FIG. 7. As shown in FIG. 7, a task was received for the user Seth on Feb. 21, 2014 from Andy Weixler requesting that Seth “[n]eed to check to see if Dr. Baker was billed correctly.” In this example, although not shown, the task may include a reference to data corresponding to Dr. Baker's last bill and, when opened by the user Seth, will pull the billing data directly from the healthcare relationship management system database.

Referring now to FIG. 2F, there is shown a flowchart 2000 of an example import of an external communication according to execution of the method 280. As shown in FIG. 2F, the flowchart 2000 includes an external communication 2061, a standard Inbox 2062, a healthcare relationship management system 2064a, a provider record within the healthcare relationship management system 2064b, and a communication center generated by the healthcare relationship management system 2064c.

As discussed in the method 280, the external communication 2061 may be sent to a standard Inbox 2062 (i.e. a corporate mailbox, Gmail, Yahoo! Mail, etc.) and also a healthcare relationship management system 2064a. When sent to the healthcare relationship management system 2064a, the healthcare relationship management system 2064a will import the external communication 2061 to create a communication. The healthcare relationship management system 2064a may also associate the newly created communication with one or more provider records 2064b based on identifiers contained within the external communication 2061 (i.e. email address, called out information from reserved words, other native information). Then, when a user of the healthcare relationship management system 2064a requests his or her communication center 2064c to view all communications for the user, the communication will be displayed and the associated provider record 2064b will be shown in proximity to the communication for efficient handling.

Referring now to FIG. 3A, there is shown at least one embodiment of the components of the system 300 for healthcare relationship management according to at least one embodiment of the present disclosure. System 300 comprises user device 310, server 320, database 330, and computer network 360. For purposes of clarity, only one user device 310 is shown in FIG. 3A. However, it is within the scope of the present disclosure that the system 300 may include any number of user devices 310 at one time.

The user device 310 may be configured to transmit information to and generally interact with a web services infrastructure housed on server 320 over computer network 360. The user device 310 may include a web browser; mobile application, socket or tunnel, or other network connected software such that communication with the web services infrastructure on server 320 is possible over the computer network 360.

User device 310 includes one or more computers, smartphones, tablets, wearable technology, computing devices, or systems of a type well known in the art, such as a mainframe computer, workstation, personal computer, laptop computer, hand-held computer, cellular telephone, or personal digital assistant. User device 310 comprises such software, hardware, and componentry as would occur to one of skill in the art, such as, for example, one or more microprocessors, memory systems, input/output devices, device controllers, and the like. User device 310 also comprises one or more data entry means (not shown in FIG. 3A) operable by users of user device 310 for data entry, such as, for example, voice or audio control, a pointing device (such as a mouse), keyboard, touchscreen, microphone, voice recognition, and/or other data entry means known in the art. User device 310 also comprises a display means (not shown in FIG. 3A) which may comprise various types of known displays such as liquid crystal diode displays, light emitting diode display, and the like upon which information may be display in a manner perceptible to the user.

As described above, the server 320 may be configured to receive authentication information, page rendering requests, tasks, communications, and other information from the user device 310. In at least one embodiment, the server 320 accesses the database 330 to store information transmitted from the user device 310 or generated through its interaction with the server 320 in the methods and disclosed herein. The server 320 is configured to carry out one or more of the steps of methods described herein.

The user device 310 is further configured to provide input to the server 320 to carry out one or more of the steps of the methods described herein. Server 320 comprises one or more server computers, computing devices, or systems of a type known in the art. Server 320 further comprises such software, hardware, and componentry as would occur to one of skill in the art, such as, for example, microprocessors, memory systems, input/output devices, device controllers, display systems, and the like. Server 320 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 3A, server 320 is shown and referred to herein as a single server. However, server 320 may comprise a plurality of servers, virtual infrastructure, or other computing devices or systems interconnected by hardware and software systems know in the art which collectively are operable to perform the functions allocated to server 320 in accordance with the present disclosure.

The database 330 is configured to store healthcare information, patient information, reports, health care insight, and other information generated by the healthcare relationship management system and/or retrieved from one or more information sources. Database 330 is “associated with” server 320. According to the present disclosure, database 330 can be “associated with” server 320 where, as shown in the embodiment in FIG. 3A, database 330 resides on server 320. Database 330 can also be “associated with” server 320 where database 330 resides on a server or computing device remote from server 320, provided that the remote server or computing device is capable of bi-directional data transfer with server 320, such as, for example, in Amazon AWS, Rackspace, or other virtual infrastructure, or any business network. In at least one embodiment, the remote server or computing device upon which database 330 resides is electronically connected to server 320 such that the remote server or computing device is capable of continuous bi-directional data transfer with server 320.

For purposes of clarity, database 330 is shown in FIG. 3A, and referred to herein as a single database. It will be appreciated by those of ordinary skill in the art that database 330 may comprise a plurality of databases connected by software systems of a type well known in the art, which collectively are operable to perform the functions delegated to database 330 according to the present disclosure. Database 330 may comprise relational database architecture, noSQL, OLAP, or other database architecture of a type known in the database art. Database 330 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Database 330 retrievably stores information that is communicated to database 330 from user device 310 or server 320.

User device 310 and server 320 communicate via computer network 360. If database 330 is in disparate infrastructure from server 320, database 330 may communicate with server 330 via computer network 360. Computer network 360 may comprise the Internet, but this is not required.

Referring now to FIG. 3B it is shown a system 380 for healthcare relationship management according to at least one embodiment of the present disclosure. As shown in FIG. 3B, the system includes third party resources 382, a data integration layer 384, a web services layer 386, and a database 388.

As shown in FIG. 3B, the system 382 includes one or more third party resources. Third party resources may transmit data in one or more formats to the data integration layer 384 for ingestion. Third party resources may include, but are not limited to, laboratory information systems, laboratory management systems, third party databases, business process management resources, or other data repositories. The third party data resources may transmit healthcare data to the data integration layer 384 in any format, including, but not limited to, HL7, XML, JSON, SQL transport, Sockets, comma separated values, text, or otherwise.

The data integration layer 384 may comprise one or more servers configured to translate data provided from the third party resources 382 for ingestion into a healthcare relationship management system. Data provided by the third party resources 382 may come in a variety of formats, some of which may be proprietary, which need transformed or otherwise altered for ingestion into a healthcare relationship management system.

In at least one embodiment of the present disclosure, the data integration layer 384 creates objects corresponding to the translated data using one or more web services protocols (SOAP, RESTful, etc.) to the web services layer 386, which then imports data into the database 388.

In a preferred embodiment, the integration to the database 388 may be split into disparate paths for standard ingestion of content commonly used within the healthcare relationship management system and custom data specific to a healthcare organization, but this is not required.

Referring now to FIG. 3C, it is shown a logical architecture diagram of components of a healthcare relationship management system 390 with multi-tenant support and wellness automation. As shown in FIG. 3C, the healthcare relationship management system 390 includes multiple portals (391a, 391b), health care insight admin services (392a, 392b), user access control layers (393a, 393b), organization layers (394a, 394b), a provider role 396, a coach role 397, a patient role 398, and an underlying single-sign on layer 399. It should be appreciated, of course, that FIG. 3C only displays two tenants in a healthcare relationship management system 390 but any number of tenants may be supported.

In at least one embodiment of the present disclosure, the healthcare relationship management system 390 supports multiple tenant organizations 394a, 394b in the same infrastructure. In such an embodiment, each tenant organization 394a, 394b may utilize a portal 391a, 391b and healthcare insight infrastructure 392a, 392b within the same system 390. In such an embodiment, each organization is equipped with individualized authorization controls in a user access control layer (i.e. 393a, 393b) within the system 390 such that users only authorized to view data, generate reports, and otherwise access services for one organization cannot access resources for other organizations. For example, a user with organization 394a that is only authorized to access the healthcare insight layer 392a for such organization 394a cannot access the healthcare insight layer 392b for organization 394b.

Each organization, therefore, may control which users are known to the healthcare relationship management system 390 may access information and services for the organization, which is enforced at the user access control layer. It should be appreciated that an individual user within the healthcare relationship management system 390 may be authorized to view information and access services for multiple organizations.

Authentication for users and, as discussed previously, for input sources in the healthcare relationship management system 390 is performed by a single sign on service 399. The single-sign on service 399 provides authentication for users and input sources that may be leveraged by user access control layers at each individual organization (i.e. 393a, 393b). For example, a user authenticates to a healthcare relationship management system by providing credentials at a login page. The credentials are authenticated at the single-sign on service 399 and then the user is directed to the page requested. To access the requested page, one or more user access control layers is used to verify the user's authorization based on information and resources requested. For example, if the user is attempting to access data associated with organization 394a, the single-sign on service 399 authenticates the user and then the user access control layer 393a is used to authorize the user's access to such data.

In some embodiments, a user may request access to a page that would display information from multiple organizations. In this example, the single-sign-on service 399 provides authentication for the user and access control layers are utilized to verify authorization as needed for information.

As shown in FIG. 3C, the single-sign on service 399 includes the support for multiple roles within the healthcare relationship management system 390. A few examples of such roles are shown logically in FIG. 3C, including a provider 396, a coach 397, and a patient 398. In such an embodiment, the single-sign-on service 399 may associate a user and user credentials with these roles that may then be leveraged by individual organization user access control layers. At each individual user access control layer, then, the user access control layer may reference roles rather than individual users, which may create more efficient provisioning of users within the healthcare relationship management system 390. It should be appreciated that additional roles may exist within the healthcare relationship management system 390, including, for example, a device role.

Referring now to FIG. 3D, it is shown an architecture 3000 for user access control to information according to at least one embodiment of the present disclosure. As shown in FIG. 3D, the architecture 3000 includes a base user 3001, an access control tree 3002, an organization 3003, and a healthcare relationship management system 3004. This user access control model represents a high level overview of the traditional user access control model within a healthcare relationship management system as described in more detail in FIG. 3C and elsewhere herein. As shown in FIG. 3D, a user is assigned an access control tree, an organization is associated with an access control tree, and then that access control information is stored by and processed by a healthcare relationship management system in response to user requests. This traditional model provides access to provider information to a standard user when the access control tree states that such access to be provided.

Referring now to FIG. 3E, the architecture 3100 details an improvement of the user access control model for a healthcare relationship management system. As shown in FIG. 3E, the architecture 3100 is improved through the addition of collaboration user 3101, contacts 3102, collaboration sub user 3103. The components of the healthcare relationship management system 3105 and provider 3104 are maintained. In such an embodiment, the user access control model includes additional criteria for providing access to provider 3104 information (i.e. contact 3102) to multiple users with need for such, access. In such an embodiment, a contact 3102 may be assigned a specific collaboration user 3101 and collaboration sub user 3103 such that these individuals may be given access to contact 3102 even if the traditional access control tree (not shown) does not provide for such access.

For example, a general doctor (collaboration user 3101) intakes a patient at the emergency room (contact 3102). In this example, the doctor determines that the patient needs an ear, nose, and throat specialist to perform a thorough examination of the patient's throat. In this example, an ear, nose, and throat specialist (collaboration sub user 3103) may be given discrete access to the patient's information (contact 3102) in the healthcare relationship management system 3105. Through this example, both the doctor and the ear, nose, and throat specialist may access the patient's information.

It should be appreciated that this model improves upon the traditional access control model by providing discrete access to an individual user. In the traditional model, if the doctor and ear, nose, and throat specialist are not in the same organization (provider 3104), then an entire new provider would need to be added to the patient's access control regime to give access to the ear, nose, and throat specialist or the ear, nose, and throat specialist would need to be assigned the same provider as the doctor to provide such access. The improved model, however, enables the ear, nose, and throat specialist individually to have access to the patient information without needing to provide over-access to an entire provider's information set.

FIG. 4 displays a flowchart 400 of how information may flow to and through a healthcare relationship management system, such as, for example, the system 300 in FIG. 3A and the system 380 in FIG. 3B. As shown in FIG. 4, raw data may be retrieved through manual entry or an external source (i.e. LIS, EMR system, etc.). The raw data may flow through a common core infrastructure or a custom infrastructure based on the data type. This data may then be analyzed to generate business intelligence relationships. Then, the information may be sliced, filtered, aggregated, or otherwise manipulated to generate business intelligence reports, organized in business intelligence tabs, and presented in an actionable format in a business intelligence dashboard.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for healthcare relationship management, the method comprising:
receiving a health information from a healthcare communication source at a healthcare relationship system;
categorizing the health information into at least one security category based on one or more privacy rules;
receiving a request from a user for the health information at a healthcare relationship management system, the user being associated with at least one security role; and
granting or denying access to the health information for the user at the healthcare relationship management system based on an evaluation of the at least one category against the at least one security role.

2. The method of claim 1, wherein the healthcare communication source is selected from one of a lab information system, radiology information system, hospital information system, electronic medical record, data warehouse, revenue cycle management system, general ledger, accounts payable provider, a billing provider, and a customer relationship management solution.

3. The method of claim 1, further comprising:
assigning the at least one security role to the user in a database based on a job performed by the user at a healthcare organization; and
assigning at least one node to the user in the database, the node corresponding to a hierarchical view of the healthcare organization.

4. The method of claim 3, wherein the granting or denying step is further based on the at least one node.

5. The method of claim 3, further comprising:
generating a communication within the healthcare relationship management system, the communication being directed to a second user and comprising the health information; and
generating a rendering of the communication to the second user, wherein the rendering includes a redaction over the health information in the event that the second user is unauthorized to view the health information.

6. A method for healthcare relationship management, the method comprising:
receiving a health information from a healthcare communication source at a healthcare relationship system;
categorizing the health information into at least one security category based on one or more privacy rules;
receiving a request from a user for the health information at a healthcare relationship management system, the user being associated with at least one security role and at least one organization node; and
transmitting a web page based on the request, wherein the web page comprises the health information only when the at least one security role and the at least one organization node authorize the user to view the health information based on the at least one security category.

7. The method of claim 6, wherein the healthcare communication source is selected from one of a lab information system, radiology information system, hospital information system, electronic medical record, data warehouse, revenue cycle management system, general ledger, accounts payable provider, a billing provider, and a customer relationship management solution.

8. The method of claim 6, wherein the web page is a business intelligence report.

9. The method of claim 6, wherein the web page comprises a communication within the healthcare relationship management system.

10. A computerized method for healthcare relationship management, the method comprising:
receiving a communication request at a healthcare relationship management system, the communication request being associated with an external communication including one or more identifiers;
creating a communication within the healthcare relationship management system based on the communication request; and
associating the communication with one or more'health information records in a database based on the one or more identifiers.

11. The method of claim 10, wherein the external communication is an email and the one or more identifiers are email headers.

12. The method of claim 10, wherein the one or more identifiers are reserved characters or keywords identified in the healthcare relationship management system.

13. A system for healthcare relationship management, the system comprising:
a user device operated by a user;
a database, the database configured to receive a health information from a healthcare communication source and categorize the health information into at least one security category based on one or more privacy rules;
a server, the server configured to receive a request from a user device for the health information at a healthcare relationship management system, the user being associated with at least one security role, retrieve the health information from the database, and grant or deny access to the health information for the user device at the healthcare relationship management system based on an evaluation of the at least one category against the at least one security role.

14. The system of claim 13, wherein the healthcare communication source is selected from one of a lab information system, radiology information system, hospital information system, electronic medical record, data warehouse, revenue cycle management system, general ledger, accounts payable provider, a billing provider, and a customer relationship management solution.

15. The system of claim 13, wherein the server is further configured to assign the at least one security role to the user in the database based on a job performed by the user at a healthcare organization, and assign at least one node to the user in the database, the node corresponding to a hierarchical view of the healthcare organization.

16. The method of claim 15, wherein the server is,further configured to grant or deny access based on the at least one node.

17. The system of claim 15, wherein the server is further configured to generate a communication, the communication being directed to a second user and comprising the health information and transmit the communication to the user device.

18. The system of claim 17, wherein the user device is configured to render the wherein the rendering includes a redaction over the health information in the event that the second user is unauthorized to view the health information.

19. A system for healthcare relationship management, the system comprising:
a user device operated by a user;
a database, the database configured to receive a health information from a healthcare communication source and categorize the health information into at least one security category based on one or more privacy rules;
a server, the server configured to receive a request from a user device for the health information at a healthcare relationship management system, the user being associated with at least one security role and at least one organization node, retrieve the health information from the database, and transmit a web page to the user device, wherein the web page comprises the health information only when the at least one security role and the at least one organization node authorize the user to view the health information based on the at least one security category.

20. The system of claim 19, wherein the healthcare communication source is selected from one of a lab information system, radiology information system, hospital information system, electronic medical record, data warehouse, revenue cycle management system, general ledger, accounts payable provider, a billing provider, and a customer relationship management solution.
